(19) United States
(12) Patent Application Publication
(10) Pub. No.: US 2026/0332292 A1
(43) Pub. Date: Oct. 22, 2026

(54) OUTER LOOP LINK ADAPTATION ADJUSTMENT FOR WIRELESS COMMUNICATIONS

(71) Applicant: QUALCOMM Incorporated, San Diego, CA (US)

(72) Inventors: Kirill IVANOV, La Jolla, CA (US); Wei YANG, San Diego, CA (US); Jing JIANG, San Diego, CA (US)

(21) Appl. No.: 19/186,203

(22) Filed: Apr. 22, 2025

(51) Int. Cl. H04L 1/00; H04W 8/24

(52) U.S. Cl. CPC H04L 1/0003; H04L 1/0009; H04W 8/24

(57) ABSTRACT

This disclosure provides methods, components, devices, and systems for outer loop link adaptation adjustment for wireless communications. For example, a user equipment (UE) may transmit, to a network entity, information indicating successive interference cancellation (SIC) capability of the UE. The UE may receive a transmission including a first codeword and a second codeword. The UE may transmit, in response to an attempt to decode at least one of the first codeword or the second codeword, a feedback message that indicates whether the first codeword was successfully decoded, whether the second codeword was successfully decoded, or both. The UE may receive, in response to the feedback message and in accordance with the SIC capability of the UE, another transmission including the first codeword and the second codeword, where the MCS value associated with the first codeword is different from the MCS value associated with the second codeword.

### TECHNICAL FIELD

This disclosure relates generally to wireless communication, and more specifically to systems, devices, methods, and techniques associated with outer loop link adaptation adjustment for wireless communications.

### DESCRIPTION OF THE RELATED TECHNOLOGY

Communication systems are deployed to provide communication services such as voice, video, packet data, messaging, or broadcast, among others. A communication system may include a wireless communication network (such as a radio access network (RAN)) that supports communication between wireless communication devices such as network entities (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), and sixth generation (6G) systems. A wireless communication network may support communication by implementing system resources (such as frequency resources, time resources, spatial resources) in accordance with a wireless communication protocol.

### SUMMARY

In some wireless communication systems, wireless devices may use outer loop link adaptation (OLLA) to dynamically adjust a modulation and coding scheme (MCS) to match current channel conditions and ensure reliable data transmission. For example, a network entity, in communication with a user equipment (UE), may monitor feedback from the UE indicating the result of decoding a data transmission. Based on the feedback, the network entity may adjust the MCS to achieve a target transport block (TB) block error rate (BLER). By fine-tuning the link adaptation process using the UE feedback, OLLA may help achieve a balance between high data throughput and reliable transmission. In some cases, the wireless devices may implement multiple-input, multiple-output (MIMO) scenarios to increase data throughput and spectral efficiency. For example, the network entity may use a two-codeword scheme with a quantity of transmission layers greater than four, where the data is split into two codewords and each codeword carries a portion of the total data for transmission. In some cases, the UE may implement a Successive Interference Cancellation (SIC) decoding technique where the UE, after receiving multiple signals simultaneously, decodes the strongest signal first, subtracts it from the combined signal, and then decodes the remaining weaker signal. Currently, the network entity and UE do not have a mechanism for coordinating OLLA and SIC. Without coordinating the OLLA based on the UE implementing SIC, the network entity may not efficiently adjust the target BLER and the MCS to improve spectral efficiency.

Aspects of the subject matter described in this disclosure relate to OLLA adjustment for wireless communications. For example, the UE may indicate SIC capability, and the network entity may adjust the TB BLER targets and the MCS values in accordance with the SIC capability of the UE to improve spectral efficiency. In some examples, the UE may transmit, to the network entity, information indicating SIC capability of the UE. The UE may receive a transmission including a first codeword and a second codeword. The UE may attempt decode the transmission and transmit a feedback message indicating whether the first codeword was successfully decoded, whether the second codeword was successfully decoded, or both. The network entity may adjust the MCS value associated with the first codeword or the MCS value associated with the second codeword in accordance with the feedback message. The UE may receive, in response to the feedback message and in accordance with the SIC capability of the UE, another transmission including the first codeword and the second codeword, where the MCS value associated with the first codeword is different from the MCS value associated with the second codeword. In some examples, the UE may transmit, to a network entity, information indicating MCS values to skip from among a set of MCS values, and the network entity may not adjust the MCS value to one of the MCS values to skip.

The systems, methods, and devices of this disclosure each have several innovative aspects, no single one of which is solely responsible for the desirable attributes disclosed herein. The following is a summary of some non-limiting aspects of the disclosure:

A method for wireless communications by a UE is described. The method may include transmitting, to a network entity, information indicating one or more MCS values to skip from among a set of MCS values, receiving a first transmission in accordance with a first MCS value included in the set of MCS values, transmitting, in response to the first transmission, a feedback message that indicates whether the first transmission was successfully decoded, and receiving, in response to the feedback message, a second transmission in accordance with a second MCS value included in the set of MCS values, where the second MCS value is not one of the one or more MCS values to skip.

A UE for wireless communications is described. The UE may include a processing system that includes processor circuitry and memory circuitry that stores code. The processing system may be configured to cause the UE to transmit, to a network entity, information indicating one or more MCS values to skip from among a set of MCS values, receive a first transmission in accordance with a first MCS value included in the set of MCS values, transmit, in response to the first transmission, a feedback message that indicates whether the first transmission was successfully decoded, and receive, in response to the feedback message, a second transmission in accordance with a second MCS value included in the set of MCS values, where the second MCS value is not one of the one or more MCS values to skip.

Another UE for wireless communications is described. The UE may include means for transmitting, to a network entity, information indicating one or more MCS values to skip from among a set of MCS values, means for receiving a first transmission in accordance with a first MCS value included in the set of MCS values, means for transmitting, in response to the first transmission, a feedback message that indicates whether the first transmission was successfully decoded, and means for receiving, in response to the feedback message, a second transmission in accordance with a second MCS value included in the set of MCS values, where the second MCS value is not one of the one or more MCS values to skip.

A non-transitory computer-readable medium storing code for wireless communications is described. The code may include instructions executable by one or more processors to transmit, to a network entity, information indicating one or more MCS values to skip from among a set of MCS values, receive a first transmission in accordance with a first MCS value included in the set of MCS values, transmit, in response to the first transmission, a feedback message that indicates whether the first transmission was successfully decoded, and receive, in response to the feedback message, a second transmission in accordance with a second MCS value included in the set of MCS values, where the second MCS value is not one of the one or more MCS values to skip.

In some examples of the method, UEs, and non-transitory computer-readable medium described herein, the one or more MCS values to skip may be associated with one or more ranks or one or more layer mapping schemes.

In some examples of the method, UEs, and non-transitory computer-readable medium described herein, operations, features, means, or instructions for transmitting the information may include operations, features, means, or instructions for transmitting, to the network entity, a capability report indicating the one or more MCS values to skip.

In some examples of the method, UEs, and non-transitory computer-readable medium described herein, the information may be transmitted periodically or in response to a trigger event.

A method for wireless communications by a UE is described. The method may include transmitting, to a network entity, information indicating a SIC capability of the UE, receiving a first transmission including a first codeword and a second codeword, attempting to decode at least one of the first codeword or the second codeword, transmitting, in response to the attempt to decode, a feedback message that indicates whether the first codeword was successfully decoded, whether the second codeword was successfully decoded, or both, and receiving, in response to the feedback message and in accordance with the SIC capability of the UE, a second transmission including the first codeword and the second codeword, where the first codeword is associated with a first MCS value and the second codeword is associated with a second MCS value, the first MCS value different from the second MCS value.

A UE for wireless communications is described. The UE may include a processing system that includes processor circuitry and memory circuitry that stores code. The processing system may be configured to cause the UE to transmit, to a network entity, information indicating a SIC capability of the UE, receive a first transmission including a first codeword and a second codeword, attempt to decode at least one of the first codeword or the second codeword, transmit, in response to the attempt to decode, a feedback message that indicates whether the first codeword was successfully decoded, whether the second codeword was successfully decoded, or both, and receive, in response to the feedback message and in accordance with the SIC capability of the UE, a second transmission including the first codeword and the second codeword, where the first codeword is associated with a first MCS value and the second codeword is associated with a second MCS value, the first MCS value different from the second MCS value.

Another UE for wireless communications is described. The UE may include means for transmitting, to a network entity, information indicating a SIC capability of the UE, means for receiving a first transmission including a first codeword and a second codeword, means for decoding the first codeword and the second codeword, means for transmitting, in response to an attempt to decode at least one of the first codeword and or the second codeword, a feedback message that indicates whether the first codeword was successfully decoded, whether the second codeword was successfully decoded, or both, and means for receiving, in response to the feedback message and in accordance with the SIC capability of the UE, a second transmission including the first codeword and the second codeword, where the first codeword is associated with a first MCS value and the second codeword is associated with a second MCS value, the first MCS value different from the second MCS value.

A non-transitory computer-readable medium storing code for wireless communications is described. The code may include instructions executable by one or more processors to transmit, to a network entity, information indicating a SIC capability of the UE, receive a first transmission including a first codeword and a second codeword, attempt to decode at least one of the first codeword or the second codeword, transmit, in response to the attempt to decode, a feedback message that indicates whether the first codeword was successfully decoded, whether the second codeword was successfully decoded, or both, and receive, in response to the feedback message and in accordance with the SIC capability of the UE, a second transmission including the first codeword and the second codeword, where the first codeword is associated with a first MCS value and the second codeword is associated with a second MCS value, the first MCS value different from the second MCS value.

In some examples of the method, UEs, and non-transitory computer-readable medium described herein, the SIC capability is indicated per frequency band or frequency band combination.

In some examples of the method, UEs, and non-transitory computer-readable medium described herein, the second MCS value may be associated with a TB BLER target in accordance with successful decoding of the first codeword.

Some examples of the method, UEs, and non-transitory computer-readable medium described herein may further include operations, features, means, or instructions for transmitting, to the network entity, a message indicating one or more TB BLER target values associated with at least one of the first codeword or the second codeword.

In some examples of the method, UEs, and non-transitory computer-readable medium described herein, the one or more TB BLER target values are associated with one or more ranks or one or more layer mapping schemes.

In some examples of the method, UEs, and non-transitory computer-readable medium described herein, the one or more TB BLER target values are transmitted periodically or in response to a trigger event.

In some examples of the method, UEs, and non-transitory computer-readable medium described herein, the message indicates a first TB BLER target value associated with the first codeword and a second TB BLER target value associated with the second codeword.

In some examples of the method, UEs, and non-transitory computer-readable medium described herein, the second TB BLER target value is a conditional BLER target or an unconditional BLER target.

Some examples of the method, UEs, and non-transitory computer-readable medium described herein may further include operations, features, means, or instructions for transmitting, to the network entity, a channel state information report that indicates a SIC order associated with the first codeword and the second codeword.

A method for wireless communications by a network entity is described. The method may include obtaining, from a UE, information indicating a SIC capability of the UE, outputting a first transmission including a first codeword and a second codeword, obtaining, in response to the first transmission, a feedback message that indicates whether the first codeword was successfully decoded, whether the second codeword was successfully decoded, or both, and outputting, in response to the feedback message and in accordance with the SIC capability of the UE, a second transmission including the first codeword and the second codeword, where the first codeword is associated with a first MCS value and the second codeword is associated with a second MCS value, the first MCS value different from the second MCS value.

A network entity for wireless communications is described. The network entity may include a processing system that includes processor circuitry and memory circuitry that stores code. The processing system may be configured to cause the network entity to obtain, from a UE, information indicating a SIC capability of the UE, output a first transmission including a first codeword and a second codeword, obtain, in response to the first transmission, a feedback message that indicates whether the first codeword was successfully decoded, whether the second codeword was successfully decoded, or both, and output, in response to the feedback message and in accordance with the SIC capability of the UE, a second transmission including the first codeword and the second codeword, where the first codeword is associated with a first MCS value and the second codeword is associated with a second MCS value, the first MCS value different from the second MCS value.

Another network entity for wireless communications is described. The network entity may include means for obtaining, from a UE, information indicating a SIC capability of the UE, means for outputting a first transmission including a first codeword and a second codeword, means for obtaining, in response to the first transmission, a feedback message that indicates whether the first codeword was successfully decoded, whether the second codeword was successfully decoded, or both, and means for outputting, in response to the feedback message and in accordance with the SIC capability of the UE, a second transmission including the first codeword and the second codeword, where the first codeword is associated with a first MCS value and the second codeword is associated with a second MCS value, the first MCS value different from the second MCS value.

A non-transitory computer-readable medium storing code for wireless communications is described. The code may include instructions executable by one or more processors to obtain, from a UE, information indicating a SIC capability of the UE, output a first transmission including a first codeword and a second codeword, obtain, in response to the first transmission, a feedback message that indicates whether the first codeword was successfully decoded, whether the second codeword was successfully decoded, or both, and output, in response to the feedback message and in accordance with the SIC capability of the UE, a second transmission including the first codeword and the second codeword, where the first codeword is associated with a first MCS value and the second codeword is associated with a second MCS value, the first MCS value different from the second MCS value.

Some examples of the method, network entities, and non-transitory computer-readable medium described herein may further include operations, features, means, or instructions for determining a TB BLER target associated with the second codeword in accordance with whether the feedback message indicates a successful decode for the first codeword.

Some examples of the method, network entities, and non-transitory computer-readable medium described herein may further include operations, features, means, or instructions for obtaining a message indicating one or more TB BLER target values associated with at least one of the first codeword or the second codeword.

In some examples of the method, UEs, and non-transitory computer-readable medium described herein, the one or more TB BLER target values are associated with one or more ranks or one or more layer mapping schemes.

In some examples of the method, UEs, and non-transitory computer-readable medium described herein, the message indicates a first TB BLER target value associated with the first codeword and a second TB BLER target value associated with the second codeword.

In some examples of the method, UEs, and non-transitory computer-readable medium described herein, the second TB BLER target value is a conditional BLER target or an unconditional BLER target.

Some examples of the method, network entities, and non-transitory computer-readable medium described herein may further include operations, features, means, or instructions for obtaining a channel state information report that indicates a SIC order associated with the first codeword and the second codeword.

### BRIEF DESCRIPTION OF THE DRAWINGS

FIG. 1 shows an example of a wireless communication system.

FIG. 2 shows an example of a signaling configuration that supports outer loop link adaptation adjustment for wireless communications.

FIG. 3 shows an example of a process flow that supports outer loop link adaptation adjustment for wireless communications.

FIG. 4 shows an example of a process flow that supports outer loop link adaptation adjustment for wireless communications.

FIGS. 5 and 6 show block diagrams of devices that support outer loop link adaptation adjustment for wireless communications.

FIG. 7 shows a block diagram of a processing system that supports outer loop link adaptation adjustment for wireless communications.

FIG. 8 shows a diagram of a system including a device that supports outer loop link adaptation adjustment for wireless communications.

FIGS. 9 and 10 show block diagrams of devices that support outer loop link adaptation adjustment for wireless communications.

FIG. 11 shows a block diagram of a processing system that supports outer loop link adaptation adjustment for wireless communications.

FIG. 12 shows a diagram of a system including a device that supports outer loop link adaptation adjustment for wireless communications.

FIGS. 13 through 15 show flowcharts illustrating methods that support outer loop link adaptation adjustment for wireless communications.

Details of aspects and advantages of the subject matter in this disclosure are set forth in the drawings and accompanying descriptions. Like reference numbers and designations in the various drawings indicate like elements.

### DETAILED DESCRIPTION

A communication system may include a radio access network (RAN) that supports wireless communication. Communication of a RAN may be performed in accordance with one or more radio access technologies (RATs), including 4G, 5G, or 6G, among others, including technologies not explicitly mentioned herein. A RAT may employ access technologies (such as multiplexing technologies) including code division multiple access (CDMA), time division multiple access (TDM A), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others.

To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

In some wireless communication systems, wireless devices may use outer loop link adaptation (OLLA) to dynamically adjust a modulation and coding scheme (MCS) to match current channel conditions and ensure reliable data transmission. For example, a network entity, in communication with a user equipment (UE), may monitor feedback from the UE indicating the result of decoding a data transmission. Based on the feedback, the network entity may adjust the MCS to achieve a target transport block (TB) block error rate (BLER). By fine-tuning the link adaptation process using the UE feedback, OLLA may help achieve a balance between high data throughput and reliable transmission. In some cases, the wireless devices may implement multiple-input, multiple-output (MIMO) scenarios to increase data throughput and spectral efficiency. For example, the network entity may use a two-codeword scheme with a quantity of transmission layers greater than four, where the data is split into two codewords and each codeword carries a portion of the total data for transmission. In some cases, the UE may implement a Successive Interference Cancellation (SIC) decoding technique where the UE, after receiving multiple signals simultaneously, decodes one of the signals first, subtracts it from the combined signal, and then decodes the remaining signal. Currently, the network entity and UE do not have a mechanism for coordinating OLLA and SIC. Without coordinating the OLLA based on the UE implementing SIC, the network entity may not efficiently adjust the target BLER and the MCS to improve spectral efficiency.

Aspects of the subject matter described in this disclosure relate to OLLA adjustment for wireless communications. For example, the UE may indicate SIC capability, and the network entity may adjust the TB BLER targets and the MCS values in accordance with the SIC capability of the UE to improve spectral efficiency. In some examples, the UE may transmit, to the network entity, information indicating SIC capability of the UE. The UE may receive a transmission including a first codeword and a second codeword. The UE may decode the transmission and transmit a NAK feedback indicating that the first codeword or the second codeword was not successfully decoded. The network entity may adjust the MCS value associated with the first codeword or the MCS value associated with the second codeword in accordance with the NAK feedback. The UE may receive, in response to the NAK feedback and in accordance with the SIC capability of the UE, another transmission including the first codeword and the second codeword, where the MCS value associated with the first codeword is different from the MCS value associated with the second codeword. In some examples, the UE may transmit, to a network entity, information indicating MCS values to skip from among a set of MCS values, and the network entity may not adjust the MCS value to one of the MCS values to skip. The UE may transmit, to the network entity, a TB BLER target value associated with the first codeword and/or a TB BLER target associated with the second codeword, and the network entity may set TB BLER and adjust the MCS values for the first codeword and second codeword in accordance with the UE indicated TB BLER targets.

Particular aspects of the subject matter described in this disclosure can be implemented to realize one or more of the following potential advantages. In some examples, by coordinating OLLA and SIC, the described techniques can be used to improve throughput and spectral efficiency. In some cases, the UE indicating MCS values to skip, the described techniques can be used to improve latency and spectral efficiency. In some examples, the UE indicating the SIC capability, the described techniques can be used to improve throughput and spectral efficiency.

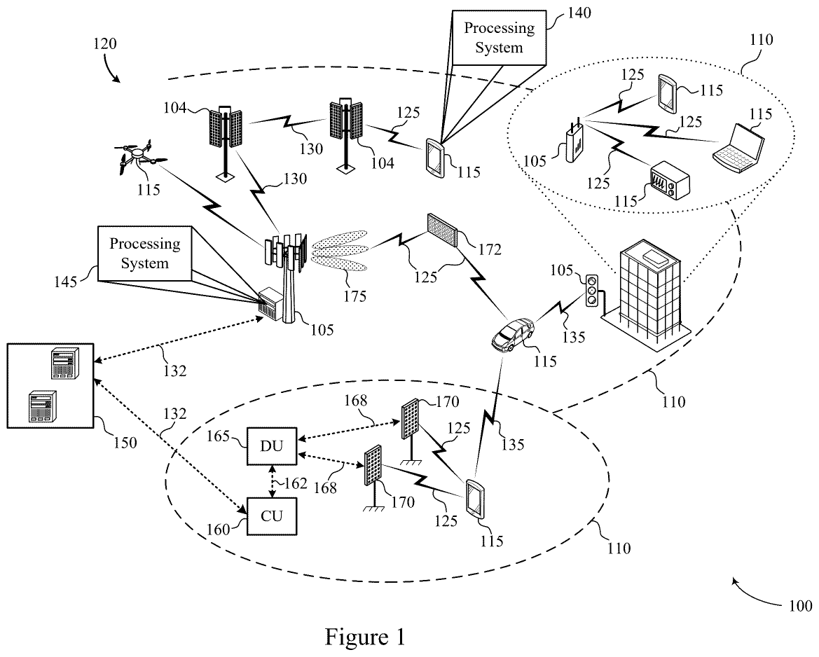

FIG. 1 shows an example of a wireless communication system 100. The wireless communication system 100 includes a core network 150 and a RAN 120 that support communication with one or more devices, such as UEs 115. A RAN 120 may include one or more network entities 105 configured to support wireless communication with the UEs 115.

The wireless communication system 100 may support communication among network entities 105 and UEs 115 in accordance with a layered protocol stack. For example, in a user plane, communication at a bearer layer, a Packet Data Convergence Protocol (PDCP) layer, or Service Data Adaption Protocol (SDAP) layer may be Internet Protocol (IP)-based. A Radio Link Control (RLC) layer may perform packet segmentation and reassembly to communicate via logical channels. A Medium Access Control (MAC) layer may perform priority handling and multiplexing of logical channels into transport channels. A MAC layer also may implement error detection techniques, error correction techniques, or retransmissions. In a control plane, a Radio Resource Control (RRC) layer may provide establishment, configuration, and maintenance of an RRC connection between UEs 115 and a network entity 105 or a core network 150, supporting radio bearers for user plane data. A Physical (PHY) layer may map transport channels to physical channels.

A core network 150 may support user authentication, access authorization, tracking, IP connectivity, and other access, routing, or mobility functions (such as via network entities 105). A core network 150 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network entity 105 may support wireless communication in accordance with one or more coverage areas 110, and may be referred to as a network element, a network node, a RAN node, or network equipment, among other nomenclature. One or more of the network entities 105 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication system 100 may include a heterogeneous network in which different types of network entities 105 support communication for one or more coverage areas 110 using the same or different RATs.

In some examples, a network entity 105 may be implemented in an aggregated (such as monolithic, standalone) architecture, which may utilize a protocol stack that is physically or logically integrated within one network entity 105 (such as a single physical RAN node). In some other examples, a network entity 105 may be implemented in a disaggregated architecture, which may utilize a protocol stack that is physically or logically distributed among multiple network entities 105, including in an integrated access and backhaul (IAB) network, an open RAN (O-RAN), or a virtualized RAN (vRAN). In a disaggregated architecture, a network entity 105 may include or be referred to as one or more of a central unit (CU) (such as CU 160), a distributed unit (DU) (such as DU 165), a radio unit (RU) (such as RU 170), or a combination thereof. The wireless communication system 100 may also implement a service-based architecture that provides a modular framework in which control plane functionality and common data repositories may be delivered through a set of interconnected network functions (NFs) that may access services of other NFs.

UEs 115 may be located in a coverage area 110 of one or more network entities 105, and may include or be referred to as an access terminal, a mobile station, a client device, or a subscriber unit. A UE 115 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

The wireless communication system 100 may support various types of communication links among devices. For example, wireless communication between a network entity 105 and a UE 115 may be supported using one or more of a communication link 125 (such as a Uu interface), which may include downlink communication from a network entity 105 to a UE 115, uplink communication from a UE 115 to a network entity 105, or both. Direct wireless communication between UEs 115 may be supported using a communication link 135 (such as a device-to-device (D2D) communication link, a sidelink, a PC5 interface).

Communication between a network entity 105 and a core network 150 may be supported using a backhaul link 132 (such as an S1, N2, N3, NG, or other interface). In some implementations, communication between network entities 105 may be supported using a backhaul link 132 (such as an X2, Xn, or other interface) either directly (such as directly between network entities 105) or indirectly (such as via a core network 150). In some implementations (such as in a disaggregated architecture), communication between a CU 160 and a DU 165 may be supported using a midhaul link 162, and communication between a DU 165 and an RU may be supported using a fronthaul link 168. A backhaul link 132, a midhaul link 162, a fronthaul link 168, or any combination thereof may be or include one or more wired links (such as an electrical link, an optical fiber link) or one or more wireless links (such as a radio link, a wireless optical link), among other examples or combinations thereof. Wireless backhaul, midhaul, or fronthaul may be implemented via one or more IAB nodes 104, which may act as a relay using resources of an IAB donor network entity 105 (such as via a wireless link 130).

The wireless communication system 100 may include one or more of a relay 172 that may steer or reflect signals transmitted by other entities, which may support any of the described communication links. A relay 172 may include active elements or passive elements, and may be in the form of a reconfigurable intelligent surface (RIS). An RIS may include tunable reflecting antenna arrays or metasurfaces, which may be used to enhance coverage or efficiency in multipath environments.

Network entities 105 and UEs 115 each may include one or multiple antennas. Multiple antennas of such devices may be used to employ techniques such as transmit diversity, receive diversity, MIMO communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some implementations, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network entity 105 or a UE 115.

Beamforming, such as directional transmission or directional reception, is a signal processing technique that may be used at a transmitting device or a receiving device (such as at a network entity 105, at a UE 115) to shape or steer a beam 175 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or both to signals carried via (such as transmitted by, received by) antenna elements of the device, which may be defined by a beamforming weight set associated with a particular orientation (such as relative to the antenna array of the device).

Communication resources of the wireless communication system 100 (such as of a RAN 120) may refer to a resource in the frequency domain (such as a frequency resource, an RF resource), a resource in the time domain (such as a time resource), a resource in the spatial domain (such as a spatial resource, a spatial layer), or a combination thereof. The wireless communication system 100 may leverage orthogonality of such resources to convey different communications to or from different devices (such as for a communication link 125, for a communication link 135, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR1), between 425 M Hz and 7.125 GHz), a mid-band (such as Frequency Range 3 (FR3), between 7.125 GHz and 24.25 GHZ), or an upper frequency band (such as Frequency Range 2 (FR2), between 24.25 GHz and 71 GHz). Communication in the upper frequency band may be referred to as millimeter wave (mmW) communication, and communication above an upper frequency band (such as between mmW and THz frequencies, between 100 GHz and 1 THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, bandwidth parts (BWPs), or both. For example, a resource block (RB), such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration), or may be configured to carry both downlink and uplink communication (such as in a time division duplexing (TDD) configuration, in a sub-band full duplex (SBFD) configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network entity 105), including in response to network conditions (such as to allocate uplink and downlink BWPs in response to traffic conditions), device capability (such as allocating BWPs with a greater quantity of RBs to UEs 115 with relatively higher capabilities), or both. A UE 115 may be configured with a set of multiple BWPs (such as a set of uplink BWPs, a set of downlink BWPs, or both), and a single BWP of a set (such as an active UL BWP, an active DL BWP, or both) may be active at a given time, such that communication of a UE 115 is supported by active BWP(s).

A time resource may refer to a duration of a frame (such as a radio frame, a frame structure), or portion thereof. For example, a frame may span a duration of 10 ms, and each frame may be identified by a system frame number (SFN). A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network entity 105, a UE 115) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication system 100 (such as of a RAN 120) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-S-OFDM), among others.

Physical channels may carry information using modulation symbols conveyed by corresponding REs. Physical shared channels (such as for communicating user data) may include a physical downlink shared channel (PDSCH) for communicating user data in a downlink direction and a physical uplink shared channel (PUSCH) for communicating user data in an uplink direction. Physical control channels (such as for managing communication via physical channels) may include a physical downlink control channel (PDCCH) for communicating downlink control information (DCI) and a physical uplink control channel (PUCCH) for communicating uplink control information (UCI). A network entity 105 may indicate (such as schedule, allocate) communication resources for a UE 115 using DCI, including indicating downlink resources of a PDSCH (such as in accordance with a downlink grant), uplink resources of a PUSCH (such as in accordance with an uplink grant), or a combination thereof. A control region (such as a control resource set (CORESET)) for a physical control channel may be configured in accordance with a pattern of REs in the time and frequency domains, and one or more control regions may be configured for a set of UEs. A UE 115 may monitor control regions for control information according to one or more search space sets, which may include a common search space set (such as for sending control information to one or more UEs 115), UE-specific search space sets (such as for sending control information to a UE 115), or a combination thereof. A physical broadcast channel (PB CH) may be used to broadcast parameters to UEs 115 to synchronize with a network entity 105 and establish communications (such as to establish a communication link 125).

Reference signals may be communicated to establish reference characteristics (such as a frequency reference, a temporal reference, a spatial reference, a signal quality reference) between devices of a RAN 120, which may support communication using physical channels. Reference signals communicated between network entities 105 and UEs 115 may include synchronization signals (such as a primary synchronization signal (PSS), a secondary synchronization signal (SSS)) that support temporal synchronization, channel state information-reference signals (CSI-RSs) that support evaluating downlink channel characteristics, sounding reference signals (SR Ss) that support evaluating uplink channel characteristics, demodulation reference signals (DM RSs) that support demodulation, or phase tracking reference signals (PTRSs) for evaluating oscillator characteristics, among others. Network entities 105 and UEs 115 may receive and measure transmitted reference signals to support one or more of these and other functions.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, where the device may provide HARQ feedback in a specific slot for data received via a previous symbol of the slot. In some other examples, the device may provide HARQ feedback via a subsequent slot or according to some other time interval.

Devices in the wireless communication system 100 (such as network entities 105, UEs 115) may modulate and code information prior to transmission of a signal (such as of a physical channel). A MCS may define how modulation and coding is to be performed, which may include an implementation in accordance with a modulation order and a target code rate. A code rate may be achieved using a channel coding scheme such as forward error correction (FEC) (such as to add redundancy). Examples of FEC include block codes, convolutional codes, and linear error-correcting codes. At a receiver (such as to demodulate modulation symbols of a physical channel), a decoder may employ probabilistic or iterative techniques to perform soft decision-making, and code blocks for bit streams may employ a check code (such as a cyclic redundancy check (CRC) code, a low-density parity-check (LDPC)) to detect and correct decoding errors.

Devices of the wireless communication system 100 may be configured to support one or more aspects of the described techniques for outer loop link adaptation adjustment for wireless communications. For example, a UE 115 may include a processing system 140, and a network entity 105 may include a processing system 145, each of which may be configured to cause the respective device to perform (such as being configured as means for performing) one or more of the described operations. By configuring a processing system 140, a processing system 145, or a combination thereof in accordance with the described techniques, the communication system 100 (such as the RAN 120) may support improve throughput and spectral efficiency.

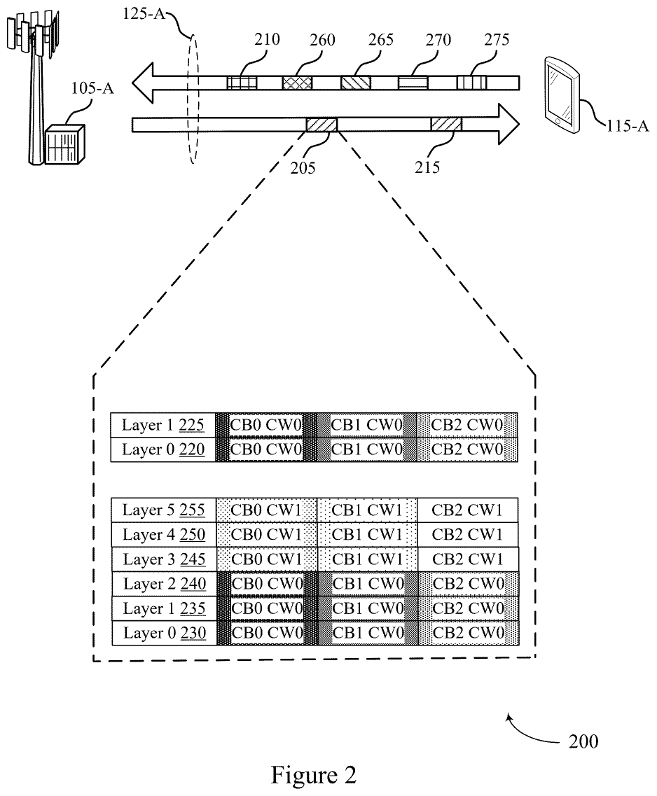

FIG. 2 shows an example of a signaling configuration 200 that supports outer loop link adaptation adjustment for wireless communications. The signaling configuration 200 may implement aspects of or may be implemented by aspects of the wireless communications system 100. For example, the signaling configuration 200 includes a UE 115-a, which may be an example of a UE 115 as described herein. The signaling configuration 200 may also include a network entity 105-a, which may be an example of a network entity 105 as described herein.

The UE 115-a may communicate with the network entity 105-a using a communication link 125-a. The communication link 125-a may be an example of a 6th generation (6G), a NR, or LTE link between the UE 115-a and the network entity 105-a. The communication link 125-a may include bi-directional links that enable both uplink and downlink communications. For example, the network entity 105-a may transmit downlink signals, such as downlink control signals, downlink reference signals, and downlink data signals, to the UE 115-a using the communication link 125-a, and the UE 115-a may transmit uplink signals, including uplink control signals, uplink reference signals, and uplink data signals to the network entity 105-a using the communication link 125-a.

In some cases, the network entity 105-a may operate in accordance with an OLLA scheme to maximize PDSCH throughput while tracking the various channel conditions. OLLA may be a mechanism applied by the network entity 105-a to adapt the transmission parameters to channel conditions in order to keep the TB BLER at a particular level. For example, the network entity 105-a may adjust the MCS to match the current channel conditions and ensure reliable data transmission.

In some examples, the network entity 105-a may select an MCS index for a data transmission 205. The network entity 105-a may transmit the downlink transmission using the selected MCS value. The UE 115-a may receive and decode the data transmissions 205. The UE 115-a may transmit feedback 210 indicating successful decoding with an acknowledgment (ACK) message or unsuccessful decoding with a non-acknowledgment (NAK or NACK) message. The network entity 105-a may use the feedback (e.g., ACK or NAK) to adjust the MCS (e.g., select a different MCS Index or MCS value) for the next downlink transmission 215. Table I illustrates an MCS index table for PDSCH. In some cases, the network entity 105-a may select the MCS value from Table I or a similar table.

TABLE I

| MCS Index | Modulation Order | Target Code Rate | Spectral |
|---|---|---|---|
| I_{MCS} | Qₘ | R × [1024] | Efficiency |
| 0 | 2 | 120 | 0.2344 |
| 1 | 2 | 193 | 0.3770 |
| 2 | 2 | 308 | 0.6016 |
| 3 | 2 | 449 | 0.8770 |
| 4 | 2 | 602 | 1.1758 |
| 5 | 4 | 378 | 1.4766 |
| 6 | 4 | 434 | 1.6953 |
| 7 | 4 | 490 | 1.9141 |
| 8 | 4 | 553 | 2.1602 |
| 9 | 4 | 616 | 2.4063 |
| 10 | 4 | 658 | 2.5703 |
| 11 | 6 | 466 | 2.7305 |
| 12 | 6 | 517 | 3.0293 |
| 13 | 6 | 567 | 3.3223 |
| 14 | 6 | 616 | 3.6094 |
| 15 | 6 | 666 | 3.9023 |
| 16 | 6 | 719 | 4.2129 |
| 17 | 6 | 772 | 4.5234 |
| 18 | 6 | 822 | 4.8164 |
| 19 | 6 | 873 | 5.1152 |
| 20 | 8 | 682.5 | 5.3320 |
| 21 | 8 | 711 | 5.5547 |
| 22 | 8 | 754 | 5.8906 |
| 23 | 8 | 797 | 6.2266 |
| 24 | 8 | 841 | 6.5703 |
| 25 | 8 | 885 | 6.9141 |
| 26 | 8 | 916.5 | 7.1602 |
| 27 | 8 | 948 | 7.4063 |

| | | |
|---|---|---|
| 28 | 2 | reserved |
| 29 | 4 | reserved |
| 30 | 6 | reserved |

The network entity 105-a may perform the MCS adjustment to achieve a target TB BLER value. For example, the target TB BLER may be set to 10% which means the UE 115-a should expect approximately 10% of the transmitted data blocks to be received with errors (e.g., not successfully decoded), requiring retransmission, while the remaining 90% should be received successfully. In some cases, the network entity 105-a may utilize the OLLA technique to improve throughput. The network entity 105-a may estimate an instantaneous signal to noise ratio (SN R) associated with the downlink transmission, and the network entity 105-a may adjust the estimated instantaneous SNR based on the received feedback from the UE 115-a. For example, the network entity 105-a may increase the SNR estimate based on the received ACK feedback or decrease the SNR estimate based on received NACK feedback. The network entity 105-a may adjust the MCS for the next transmission according to the new SNR estimate. The target TB BLER may determine the size of the SNR update step.

In some examples, the network entity 105-a and the UE 115-a may implement multiple-input, multiple-output (MIMO) scenarios to increase data throughput and spectral efficiency. In MIMO, multiple layers represent independent data streams transmitted simultaneously using multiple antennas. For example, the data transmission 205 may be transmitted via two layers (e.g., layer0 220 and layer1 225). The MIMO layer mapping for the data transmission 205 may include three codeblocks (e.g., codeblock0, codeblock1, and codeblock2) and a single codeword (e.g., CW0).

To simplify the receiver complexity for multiple layers (e.g., eight layers), instead of transmitting a single codeword over all layers, two codewords may be transmitted, and each codeword may occupying a subset of the layers. For example, the data transmission 205 may be transmitted via six layers (e.g., layer0 230, layer1 235, layer2 240, layer3 245, layer4 250, and layer5 255) with two codewords (CW0 and CW1). The MIMO layer mapping for the data transmission 205 may include three codeblocks (e.g., codeblock0, codeblock1, and codeblock2) and two codewords (e.g., CW0 and CW1). When the data transmission 205 includes two codewords, the network entity 105-a may use two outer loops to separately track MCS values for each of the codewords. OLLA may not achieve spectral efficiency improvements for scenarios with greater than four MIMO layers, for the two codeword scheme, and for the case of different MIMO layer mapping and the implemented UE demapper.

In some cases, the UE 115-a (or a receiving wireless device) may implement SIC. SIC is a decoding technique where the UE 115-a first decodes one of a set of signals. Once the first signal is decoded, the UE 115-a removes or cancels the interference caused by that signal from the received signal. The UE 115-a then proceeds to decode another of the signals in accordance with the interference from the previously decoded signal being removed. The process of decoding and interference cancellation may continue until all signals are decoded. The SIC process improves spectral efficiency and mitigates interference. In some cases, the SIC order may be fixed. For example, when SIC order is fixed, the UE 115-a may always first decode the first codeword and remove the interference caused by the first codeword before decoding the second codeword, or alternatively may always first decode the second codeword and remove the interference caused by the second codeword before decoding the first codeword.

In some cases, the network entity 105-a may not be aware of the UE 115-a supporting SIC. Currently, the UE 115-a transmitting, to the network entity, a channel quality indicator (CQI) may indicate SIC support. In some cases, the UE 115-a may have no knowledge of the OLLA TB BLER target of the network entity 105-a for each of the two codewords. If the UE 1156-a implements SIC and the network entity 105-a sets up the OLLA BLER target in the wrong way, then the UE 115-a may not benefit from SIC. In some cases, the network entity 105-a may benefit from knowing the UE 115-a uses SIC in order to adjust the BLER targets for OLLA. In case of SIC operation for the data transmission with two codewords, decoding of the second codeword may be performed if decoding of the first codeword succeeds, so the BLER target for second codeword may be set to a different BLER target than the BLER target for first codeword or a conditional BLER based on the successful decoding of the first codeword. Codeword-level SIC may provide both performance and complexity advantages, since the second codeword may be demodulated via minimum mean square error (MMSE) instead of nonlinear demodulation (e.g., reduced-complexity maximum likelihood (rML)). Due to the existing lack of coordination between UE 115-a and network entity 105-a for SIC, the UE 115-a may implement full non-linear MIMO demodulation for all layers to work with the network entity 105-a that does not implement SIC based OLLA.

In some cases, the UE 115-a may receive the data transmission via spatially coupled MIMO. For a single codeword design with spatial coupling (e.g., D-BLAST type), the single codeword rate may be selected to match the collective channel quality across multiple layers. The code structure may have the one codeword capturing more channel realizations, such as illustrated below with two layers:

| | | | |
|---|---|---|---|
| Layer 1 | | CB0 part 1 CW0 | CB0 part 1 CW0 |
| Layer 0 | CB0 part 0 CW0 | CB1 part 0 CW0 | CB0 part 2 CW0 |

For demapping the code structure with two layers using SIC, the first codeblock (e.g., CB0 may be demodulated and decoded first. In case of successful decoding, the first codeblock may be subtracted from the received signal providing the code structure below:

| | | |
|---|---|---|
| Layer 1 | | CB0 part 1 CW0 |
| Layer 0 | CB1 part 0 CW0 | CB0 part 2 CW0 |

Next, the second codeblock (CB1) may be demodulated and decoded. In case of successful decoding, the second codeblock may be subtracted from the received signal, and the procedure is repeated until all of the codeblocks are successfully decoded or codeblock decoding failure is declared.

In some cases, the rML receiver and MMSE receiver may have different performance for identical MCS values (e.g., for the 256 Quadrature Amplitude Modulation (QAM) scheme), and modulation switch points may be different. For an MM SE demapper, MCS 19 and 20 (e.g., indices or values 19 and 20) that correspond to 64QAM and high coding rate perform worse than MCS 21-23 with 256QAM and lower coding rate. In some cases, to maximize throughput, the MCS values 21-23 may be skipped.

In some examples, the UE 115-a may transmit, to the network entity 105-a, information 260 indicating a list of MCS values to skip. In some cases, the list of MCS values to skip may be reported for each rank and each layer mapping scheme. The list of MCS values may be a part of capability report (e.g., if the UE 115-a has MMSE demodulation, for single cable MIMO (SC-MIMO), some MCS values are to be skipped). In some cases, the list of MCS values to skip may be signaled via UCI or RRC. The list of values to skip may be periodically reported or may be triggered by some events on the UE side. For example, the event may trigger event may be switching between an MMSE demapper and a rML demapper (e.g., some MCS values may be skipped when switching from the MMSE demapper to the rML demapper, and some MCS values may be skipped when switching from the rML demapper to the MMSE demapper).

In some examples, to enable the network entity 105-a and the UE 115-b to improve coordination for OLLA with SIC, the UE 115-a may transmit, to the network entity 105-a, information 265 indicating a SIC capability of the UE 115-a. For example, the UE 115-a may transmit a UE capability report containing an indication of whether the UE 115-a is capable of SIC. In some cases, the UE 115-a may indicate that the UE is capable of SIC for the two codeword case. In some examples, the indication may be an explicit indication via a flag or an implicit indication via a buffer size, a quantity of HARQ processes that indicate the UE capability to store the received samples and the channel matrix. In some cases, the SIC capability may be reported per frequency band or frequency band combination. The network entity 105-a may use the information indicating SIC capability to adjust OLLA. For example, in the case of two codewords and SIC, the second codeword (e.g., CW1) may have much higher associated MCS than the first codeword (CW0), so the outer loop for first codeword may operate differently compared to the outer loop for second codeword. In some cases, the MCS value associated with the first codeword may be different from the MCS value associated with the second codeword. In comparison to the two codeword scheme without SIC, the two outer loops may operate similarly because the two codewords on average see similar channels.

In case of the UE 115-a implementing SIC, the network entity 105-a may set up the BLER target for the second codeword conditioned on the successful decoding of the first codeword in the two codeword scheme. For example, the MCS value associated with the second codeword may be based on a TB BLER target in accordance with successful decoding of the first codeword.

In some examples, the UE 115-a may signal a preferred TB BLER parameter via UCI or RRC. For example, the UE 115-a may transmit, to the network entity 105-c, a message 270 indicating a TB BLER target value associated with the first codeword, a TB BLER target value associated with the second codeword, or both. In some cases, the UE 115-a may transmit a single value for the TB BLER target value for the one codeword case or for the two codeword case when both outer loops have identical targets. In some cases, the UE 115-a may transmit a TB BLER target value associated with the first codeword and a different TB BLER target value associated with the second codeword. The TB BLER target values may be reported for each rank and each layer mapping scheme. In some cases, the TB BLER target values may be reported periodically or triggered by an event on the UE side. For example, UE 115-a may decide to change the BLER target value (e.g., corresponding to a switch from MMSE to non-linear demodulation or corresponding to turning on or off SIC). In some cases, the UE 115-a may indicate whether the TB BLER target for the second codeword is a conditional BLER target or an unconditional BLER target, and the indication may implicitly indicate that the UE 115-a may perform SIC.

In some examples, the UE 115-a may transmit, to the network entity 105-c, a CSI report 275 indicating a SIC order if SIC is enabled. For example, the CSI report 275 may indicate that the first codeword is decoded first and the second codeword is decoded after the first codeword or that the second codeword is decoded first and the first codeword is decoded after the second codeword.

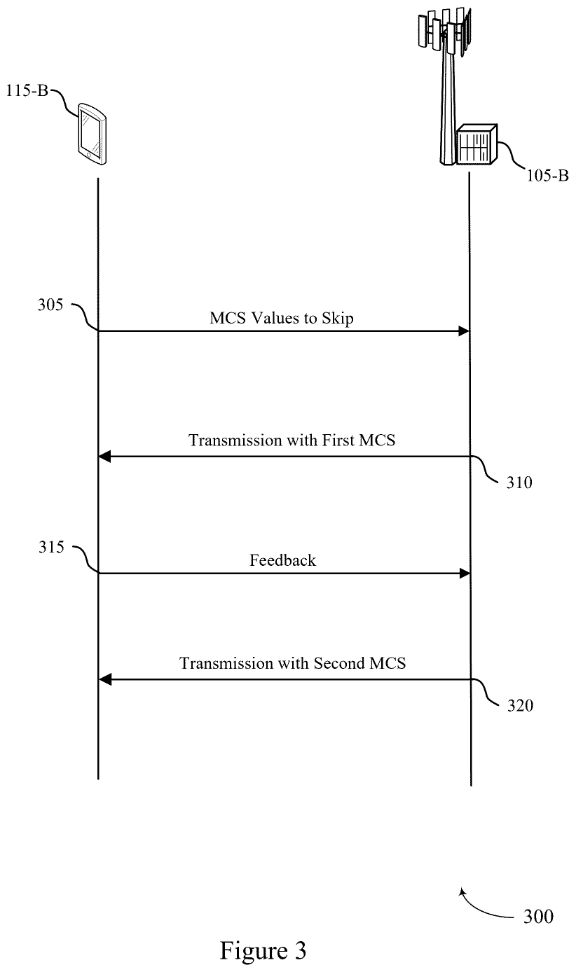

FIG. 3 shows an example of a process flow 300 that supports outer loop link adaptation adjustment for wireless communications. The process flow 300 may implement or may be implemented by aspects of the wireless communications system 100 and the signaling configuration 200. For example, the process flow 300 may include a UE 115-b and a network entity 105-b, which may be examples of the corresponding devices as described with respect to FIGS. 1 and 2. In the following description of the process flow 300, the operations between the UE 115-b and the network entity 105-b may be performed in a different order than the example order shown. Some operations may also be omitted from the process flow 300, and other operations may be added to the process flow 300. Further, although some operations or signaling may be shown to occur at different times for discussion purposes, these operations may actually occur at the same time.

At 305, the UE 115-b may transmit, to the network entity 105-b, information indicating one or more MCS values to skip from among a set of MCS values. In some cases, the one or more MCS values to skip may be associated with one or more ranks or one or more layer mapping schemes. In some examples, the UE 115-b may transmit, to the network entity 105-b, a capability report indicating the one or more MCS values to skip. In some cases, the UE 115-b may transmit the information periodically or in response to a trigger event.

At 310, the UE 115-b may receive, from the network entity 105-b, a first transmission in accordance with a first MCS value included in the set of MCS values.

At 315, the UE 115-b may transmit, in response to the first transmission, a feedback message that indicates whether the first transmission was successfully decoded (e.g., an ACK or a NAK for the first transmission).

At 320, the UE 115-b may receive, in response to the feedback message, a second transmission in accordance with a second MCS value included in the set of MCS values, and the second MCS value is not one of the one or more MCS values to skip. In some cases, the MCS adjustment may be in one direction if the feedback message is an ACK for the first transmission and may be in another direction if the feedback message is a NAK for the first transmission.

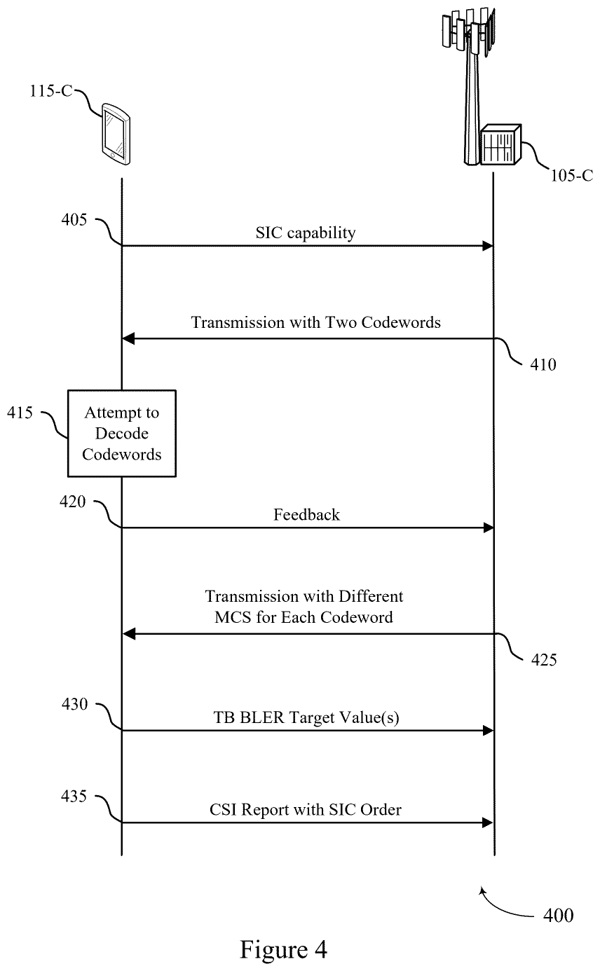

FIG. 4 shows an example of a process flow 400 that supports outer loop link adaptation adjustment for wireless communications. The process flow 400 may implement or may be implemented by aspects of the wireless communications system 100 and the signaling configuration 200. For example, the process flow 400 may include a UE 115-c and a network entity 105-c, which may be examples of the corresponding devices as described with respect to FIGS. 1 and 2. In the following description of the process flow 400, the operations between the UE 115-c and the network entity 105-c may be performed in a different order than the example order shown. Some operations may also be omitted from the process flow 400, and other operations may be added to the process flow 400. Further, although some operations or signaling may be shown to occur at different times for discussion purposes, these operations may actually occur at the same time.

At 405, the UE 115-c may transmit, to the network entity 105-c, information indicating a SIC capability of the UE. In some cases, the SIC capability may be indicated per frequency band or frequency band combination.

At 410, the UE 115-c may receive, from the network entity 105-c, a first transmission including a first codeword and a second codeword.

At 415, the UE 115-c may attempt to decode the first codeword, the second codeword, or both.

At 420, the UE 115-c may transmit, in response to the attempted decoding, a feedback message that indicates whether the first codeword was successfully decoded, whether the second codeword was successfully decoded, or both (e.g., an ACK for the first codeword and an ACK for the second codeword, an ACK for the first codeword and a NAK for the second codeword, or one or more NAKs to indicate that neither the first codeword nor the second codeword was successfully decoded. The network entity 105-c may determine a TB BLER target associated with the second codeword in accordance with whether the feedback message indicates a successful decode for the first codeword.

At 425, the UE 115-c may receive, in response to the feedback message and in accordance with the SIC capability of the UE, a second transmission including the first codeword and the second codeword. The first codeword may be associated with a first MCS value, and the second codeword may be associated with a second MCS value, where the first MCS value is different from the second MCS value. In some cases, the second MCS value may be associated with a TB BLER target in accordance with successful decoding of the first codeword.

At 430, the UE 115-c may transmit, to the network entity 105-c, a message indicating one or more TB BLER target values associated with at least one of the first codeword or the second codeword. The one or more TB BLER target values may be associated with one or more ranks or one or more layer mapping schemes. In some cases, the one or more TB BLER target values may be transmitted periodically or in response to a trigger event. In some examples, the message may indicate a first TB BLER target value associated with the first codeword and a second TB BLER target value associated with the second codeword. The second TB BLER target value may be a conditional BLER target or an unconditional BLER target.

At 435, the UE 115-c may transmit, a CSI report that indicates a SIC order associated with the first codeword and the second codeword.

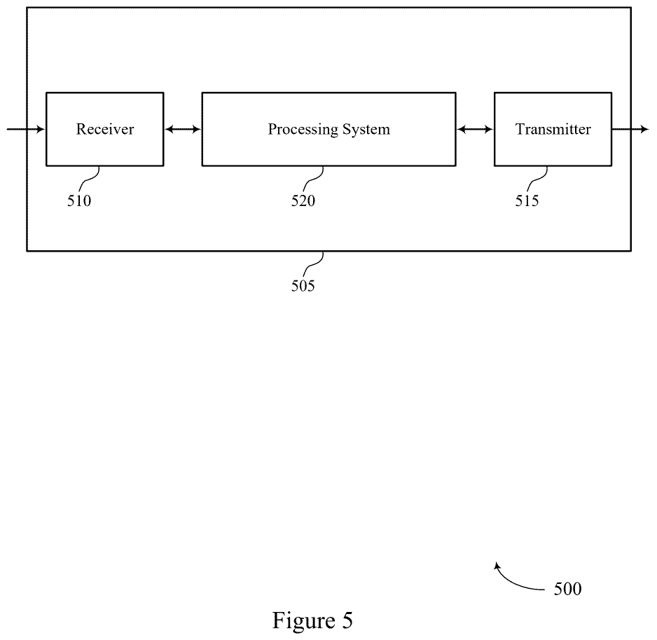

FIG. 5 shows a block diagram 500 of a device 505 that supports outer loop link adaptation adjustment for wireless communications in accordance with one or more aspects of the present disclosure. The device 505 may be an example of aspects of a UE 115 as described herein. The device 505 may include a processing system 520. The device 505, or one or more components of the device 505 (e.g., the processing system 520), may include at least one processor, which may be coupled with at least one memory, to, individually or collectively, support or enable the described techniques. Each of these components may be in communication with one another (e.g., via one or more buses).

A receiver 510 may provide a means for receiving information such as packets, user data, control information, or any combination thereof associated with various information channels (e.g., control channels, data channels, information channels related to techniques for uplink narrow beam prediction). Information may be passed on to other components of the device 505. The receiver 510 may utilize a single antenna or a set of multiple antennas.

A transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for uplink narrow beam prediction). In some examples, the transmitter 515 may be co-located with a receiver 610 in a transceiver module. The transmitter 515 may utilize a single antenna or a set of multiple antennas.

The processing system 520, the receiver 510, the transmitter 515, or various combinations or components thereof may be examples of means for performing various aspects of outer loop link adaptation adjustment for wireless communications as described herein. For example, the processing system 520, the receiver 510, the transmitter 515, or various combinations or components thereof may be capable of performing one or more of the functions described herein.

In some examples, the processing system 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (A SIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the processing system 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the processing system 520, the receiver 510, the transmitter 515, or various combinations or components thereof may be performed by a general-purpose processor, a DSP, a CPU, an A SIC, an FPGA, a microcontroller, or any combination of these or other programmable logic devices (e.g., configured as or otherwise supporting, individually or collectively, a means for performing the functions described in the present disclosure).

In some examples, the processing system 520 may be configured to perform various operations (e.g., receiving, obtaining, monitoring, outputting, transmitting) using or otherwise in cooperation with the receiver 510, the transmitter 515, or both. For example, the processing system 520 may receive information from the receiver 510, send information to the transmitter 515, or be integrated in combination with the receiver 510, the transmitter 515, or both to obtain information, output information, or perform various other operations as described herein.

The processing system 520 may support wireless communications in accordance with examples as disclosed herein. For example, the processing system 520 is capable of, configured to, or operable to support a means for transmitting, to a network entity, information indicating one or more MCS values to skip from among a set of MCS values. The processing system 520 is capable of, configured to, or operable to support a means for receiving a first transmission in accordance with a first MCS value included in the set of MCS values. The processing system 520 is capable of, configured to, or operable to support a means for transmitting, in response to the first transmission, a feedback message that indicates whether the first transmission was successfully decoded. The processing system 520 is capable of, configured to, or operable to support a means for receiving, in response to the feedback message, a second transmission in accordance with a second MCS value included in the set of MCS values, where the second MCS value is not one of the one or more MCS values to skip.

Additionally, or alternatively, the processing system 520 may support wireless communications in accordance with examples as disclosed herein. For example, the processing system 520 is capable of, configured to, or operable to support a means for transmitting, to a network entity, information indicating a SIC capability of the UE. The processing system 520 is capable of, configured to, or operable to support a means for receiving a first transmission including a first codeword and a second codeword. The processing system 520 is capable of, configured to, or operable to support a means for decoding the first codeword and the second codeword. The processing system 520 is capable of, configured to, or operable to support a means for transmitting, in response to an attempt to decode at least one of the first codeword and or the second codeword, a feedback message that indicates whether the first codeword was successfully decoded, whether the second codeword was successfully decoded, or both. The processing system 520 is capable of, configured to, or operable to support a means for receiving, in response to the feedback message and in accordance with the SIC capability of the UE, a second transmission including the first codeword and the second codeword, where the first codeword is associated with a first MCS value and the second codeword is associated with a second MCS value, the first MCS value different from the second MCS value.

By including or configuring the processing system 520 in accordance with examples as described herein, the device 505 (e.g., at least one processor controlling or otherwise coupled with the receiver 510, the transmitter 515, the processing system 520, or a combination thereof) may support techniques for more efficient utilization of communication resources.

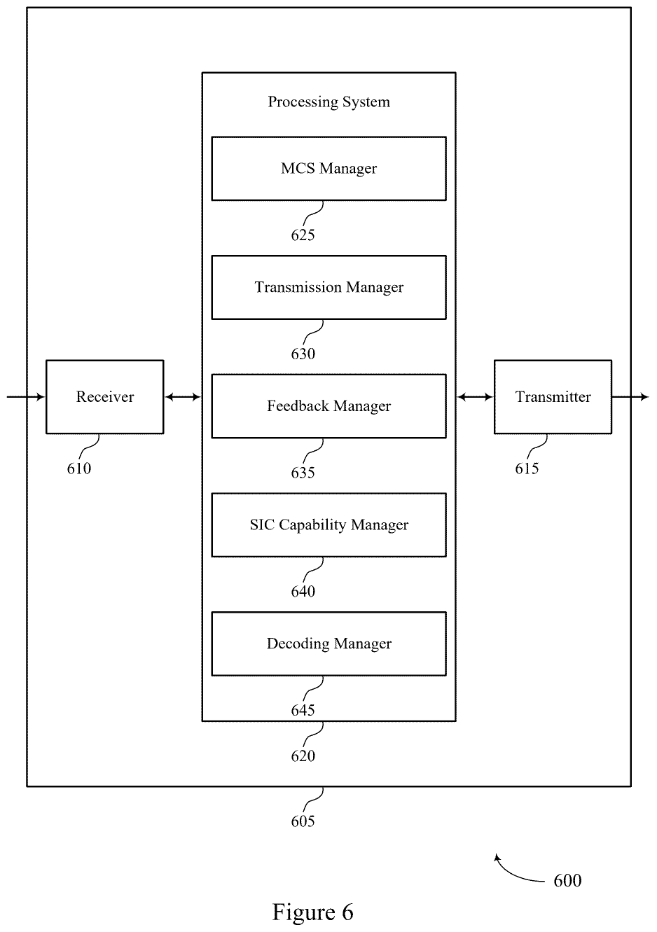

FIG. 6 shows a block diagram 600 of a device 605 that supports outer loop link adaptation adjustment for wireless communications. The device 605 may be an example of aspects of a device 505 or a UE 115 as described herein. The device 605 may include a processing system 620. The device 605, or one or more components of the device 605 (e.g., the processing system 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for uplink narrow beam prediction). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for uplink narrow beam prediction). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of outer loop link adaptation adjustment for wireless communications as described herein. For example, the processing system 620 may include an MCS manager 625, a transmission manager 630, a feedback manager 635, an SIC capability manager 640, a decoding manager 645, or any combination thereof. The processing system 620 may be an example of aspects of a processing system 520 as described herein. In some examples, the processing system 620, or various components thereof, may be configured to perform various operations (e.g., receiving, obtaining, monitoring, outputting, transmitting) using or otherwise in cooperation with the receiver 610, the transmitter 615, or both. For example, the processing system 620 may receive information from the receiver 610, send information to the transmitter 615, or be integrated in combination with the receiver 610, the transmitter 615, or both to obtain information, output information, or perform various other operations as described herein.

The processing system 620 may support wireless communications in accordance with examples as disclosed herein. The MCS manager 625 is capable of, configured to, or operable to support a means for transmitting, to a network entity, information indicating one or more MCS values to skip from among a set of MCS values. The transmission manager 630 is capable of, configured to, or operable to support a means for receiving a first transmission in accordance with a first MCS value included in the set of MCS values. The feedback manager 635 is capable of, configured to, or operable to support a means for transmitting, in response to the first transmission, a feedback message that indicates whether the first transmission was successfully decoded. The transmission manager 630 is capable of, configured to, or operable to support a means for receiving, in response to the feedback message, a second transmission in accordance with a second MCS value included in the set of MCS values, where the second MCS value is not one of the one or more MCS values to skip.

Additionally, or alternatively, the processing system 620 may support wireless communications in accordance with examples as disclosed herein. The SIC capability manager 640 is capable of, configured to, or operable to support a means for transmitting, to a network entity, information indicating a SIC capability of the UE. The transmission manager 630 is capable of, configured to, or operable to support a means for receiving a first transmission including a first codeword and a second codeword. The decoding manager 645 is capable of, configured to, or operable to support a means for decoding the first codeword and the second codeword. The feedback manager 635 is capable of, configured to, or operable to support a means for transmitting, in response to an attempt to decode at least one of the first codeword and or the second codeword, a feedback message that indicates whether the first codeword was successfully decoded, whether the second codeword was successfully decoded, or both. The transmission manager 630 is capable of, configured to, or operable to support a means for receiving, in response to the feedback message and in accordance with the SIC capability of the UE, a second transmission including the first codeword and the second codeword, where the first codeword is associated with a first MCS value and the second codeword is associated with a second MCS value, the first MCS value different from the second MCS value.

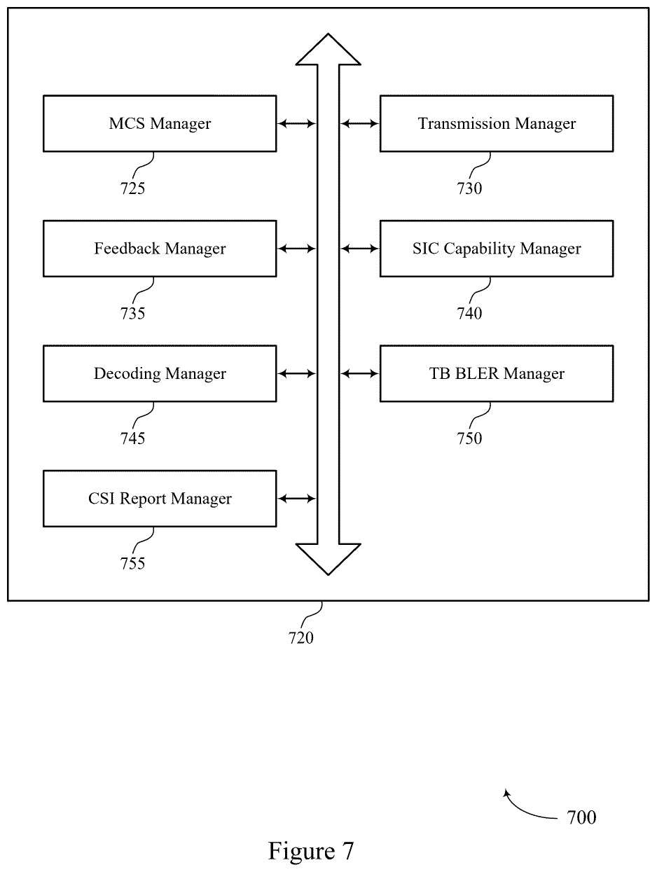

FIG. 7 shows an example of a processing system 720 that supports outer loop link adaptation adjustment for wireless communications. A processing system 720 may be an example of a processing system 140 (such as of a UE 115) and may include an MCS manager 725, a transmission manager 730, a feedback manager 735, an SIC capability manager 740, a decoding manager 745, a TB BLER manager 750, a CSI report manager 755, or any combination thereof. A processing system 720, or various component thereof, may be an example of means for performing (such as a means for causing a UE 115 to perform) various techniques described herein.

The MCS manager 725 may be configured to cause the UE 115 to transmit, to a network entity, information indicating one or more MCS values to skip from among a set of MCS values. The transmission manager 730 may be configured to cause the UE 115 to receive a first transmission in accordance with a first MCS value included in the set of MCS values. The feedback manager 735 may be configured to cause the UE 115 to transmit, in response to the first transmission, a feedback message that indicates whether the first transmission was successfully decoded. In some examples, the transmission manager 730 may be configured to cause the UE 115 to receive, in response to the feedback message, a second transmission in accordance with a second MCS value included in the set of MCS values, where the second MCS value is not one of the one or more MCS values to skip.

In some examples, the one or more MCS values to skip are associated with one or more ranks or one or more layer mapping schemes.

In some examples, to support transmitting the information, the MCS manager 725 may be configured to cause the UE 115 to transmit, to the network entity, a capability report indicating the one or more MCS values to skip.

In some examples, the information is transmitted periodically or in response to a trigger event.

Additionally, or alternatively, the SIC capability manager 740 may be configured to cause the UE 115 to transmit, to a network entity, information indicating a SIC capability of the UE. In some examples, the transmission manager 730 may be configured to cause the UE 115 to receive a first transmission including a first codeword and a second codeword. The decoding manager 745 may be configured to cause the UE 115 to attempt to decode at least one of the first codeword or the second codeword. In some examples, the feedback manager 735 may be configured to cause the UE 115 to transmit, in response to the attempt to decode, a feedback message that indicates whether the first codeword was successfully decoded, whether the second codeword was successfully decoded, or both negative. In some examples, the transmission manager 730 may be configured to cause the UE 115 to receive, in response to the feedback message and in accordance with the SIC capability of the UE, a second transmission including the first codeword and the second codeword, where the first codeword is associated with a first MCS value and the second codeword is associated with a second MCS value, the first MCS value different from the second MCS value.

In some examples, the SIC capability is indicated per frequency band or frequency band combination.

In some examples, the second MCS value is associated with a transport block TB BLER target in accordance with successful decoding of the first codeword.

In some examples, the TB BLER manager 750 may be configured to cause the UE 115 to transmit, to the network entity, a message indicating one or more TB BLER target values associated with at least one of the first codeword or the second codeword.

In some examples, the one or more TB BLER target values are associated with one or more ranks or one or more layer mapping schemes.

In some examples, the one or more TB BLER target values are transmitted periodically or in response to a trigger event.

In some examples, the message indicates a first TB BLER target value associated with the first codeword and a second TB BLER target value associated with the second codeword.

In some examples, the second TB BLER target value is a conditional BLER target or an unconditional BLER target.

In some examples, the CSI report manager 755 may be configured to cause the UE 115 to transmit, to the network entity, a channel state information report that indicates a SIC order associated with the first codeword and the second codeword.

A processing system 720 may include or be a component of one or more chips, systems-on-chips (SoCs), chipsets, packages, components, or devices that individually or collectively constitute or include a processing system. A processing system 720 may interface with other components of a processing system 720. For example, operations described with reference to a processing system 720, or various components thereof, may be performed by or with other such components, including a receiver, a transmitter, a transceiver, a modem, a user interface, a modulator/demodulator, an encoder/decoder, or any combination thereof (such as of the processing system 720, coupled with the processing system 720, of a processing system 720).

By including or configuring a processing system 720 for operation in a processing system 720 as described herein, the processing system 720 may support techniques more efficient utilization of communication resources.

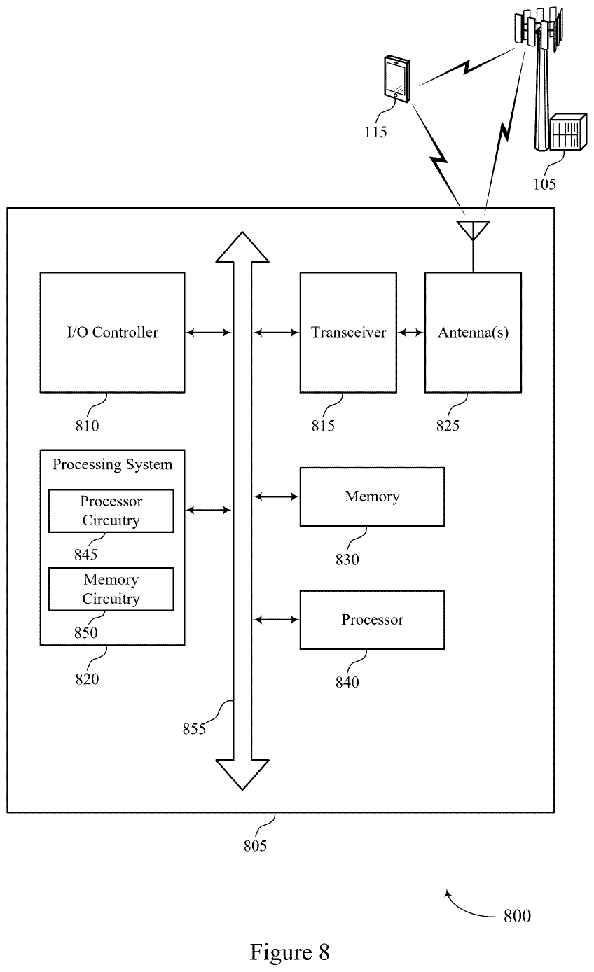

FIG. 8 shows an example of a system 800 including a device 805 that supports outer loop link adaptation adjustment for wireless communications. The device 805 may be an example of or include components of a device 505, a device 605, or a UE 115 as described herein. The device 805 may be an example of or include components of UE 115. The device 805 may communicate (such as wirelessly) with one or more other devices (such as network entities 105, UEs 115). The device 805 may include components for transmitting and receiving communication, which may include a processing system 820, an input/output (I/O) controller, such as an I/O controller 810, a transceiver 815, antenna(s) 825, a memory 830, and a processor 840. Components of the device 805 may be coupled (such as operatively, communicatively, functionally, electronically, electrically, in electronic communication) a bus 855.

The transceiver 815 may support bi-directional communication via antenna(s) 825, and may support transmission operations, reception operations, or both, as described herein. The transceiver 815 may implement functionality of a modem (such as a wireless modem) and may include one or more RF chains. An RF chain may include one or more filters, mixers, oscillators, amplifiers, analog-to-digital converters (ADCs), and other components that convert between an analog signal (such as for transmission or reception via an air interface) and a digital signal (such as for digital processing at the device 805). The transceiver 815 may modulate symbols and provide the modulated symbols to antenna(s) 825 for transmission, and demodulate symbols from signals received using antenna(s) 825.

The processor 840 may be a general-purpose processing component that supports various operations (such as applications) of the device 805. The memory 830 may be a general-purpose storage component that stores code executable by the processor 840. Such code may include instructions that, when executed by the processor 840, cause the device 805 to perform various functions (such as to support an application of the device 805). The I/O controller 810 may manage inputs and outputs for the device 805, may manage peripherals not integrated into the device 805, or may represent a physical connection (such as port) to an external peripheral. The processor 840 may interact with a modem, a keyboard, a mouse, a touchscreen, or other device (such as via I/O controller 810). In some implementations, a user may interact with the device 805 via the I/O controller 810 or via hardware components controlled by the I/O controller 810.

The processing system 820 may be an example of a processing system 140 or a processing system 700. For example, the processing system 820 may include processor circuitry 845 and memory circuitry 850 that stores code, and may be configured to cause the device 805 to perform operations that support outer loop link adaptation adjustment for wireless communications. Although the processing system 820 is illustrated as a separate component, which may involve a separate chip, chipset, or other module, in some implementations, one or more functions described with reference to the processing system 820 may be supported by or performed by a transceiver 815, antenna(s) 825, a processor 840, memory 830, or any combination thereof, such that a processing system 820 may include one or more of a transceiver 815, antenna(s) 825, a processor 840, memory 830, or any combination thereof.

By including or configuring the processing system 820 for operation in the device 805 as described herein, may support techniques for improved communication reliability, more efficient utilization of communication resources, and improved coordination between devices.

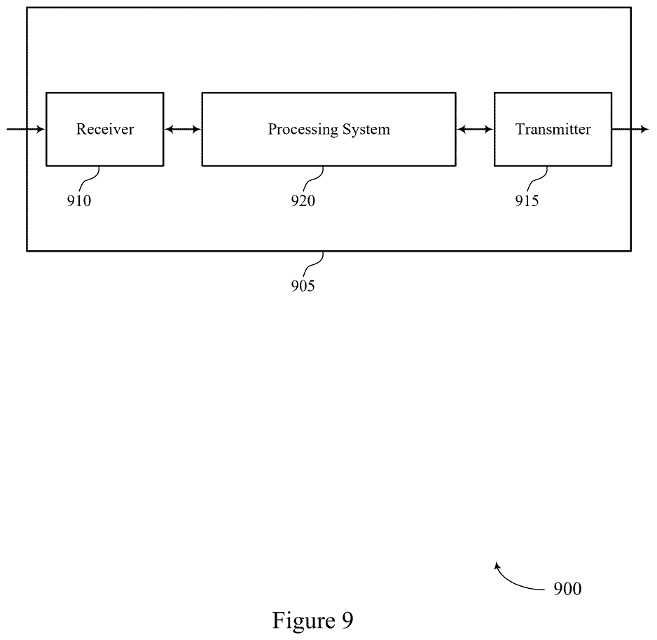

FIG. 9 shows a block diagram 900 of a device 905 that supports outer loop link adaptation adjustment for wireless communications in accordance with one or more aspects of the present disclosure. The device 905 may be an example of aspects of a network entity 105 as described herein. The device 905 may include a processing system 920. The device 905, or one or more components of the device 905 (e.g., the processing system 920), may include at least one processor, which may be coupled with at least one memory, to, individually or collectively, support or enable the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to techniques for uplink narrow beam prediction). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to techniques for uplink narrow beam prediction). In some examples, the transmitter 915 may be co-located with a receiver 910 in a transceiver module. The transmitter 915 may utilize a single antenna or a set of multiple antennas

The processing system 920, the receiver 910, the transmitter 915, or various combinations or components thereof may be examples of means for performing various aspects of outer loop link adaptation adjustment for wireless communications as described herein. For example, the processing system 920, the receiver 910, the transmitter 915, or various combinations or components thereof may be capable of performing one or more of the functions described herein.

In some examples, the processing system 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the processing system 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the processing system 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the processing system 920 may be configured to perform various operations (e.g., receiving, obtaining, monitoring, outputting, transmitting) using or otherwise in cooperation with the receiver 910, the transmitter 915, or both. For example, the processing system 920 may receive information from the receiver 910, send information to the transmitter 915, or be integrated in combination with the receiver 910, the transmitter 915, or both to obtain information, output information, or perform various other operations as described herein.

The processing system 920 may support wireless communications in accordance with examples as disclosed herein. For example, the processing system 920 is capable of, configured to, or operable to support a means for obtaining, from a UE, information indicating one or more MCS values to skip from among a set of MCS values. The processing system 920 is capable of, configured to, or operable to support a means for outputting a first transmission in accordance with a first MCS value included in the set of MCS values. The processing system 920 is capable of, configured to, or operable to support a means for obtaining, in response to the first transmission, a feedback message that indicates whether the first transmission was successfully decoded. The processing system 920 is capable of, configured to, or operable to support a means for outputting, in response to the feedback message, a second transmission in accordance with a second MCS value included in the set of MCS values, where the second MCS value is not one of the one or more MCS values to skip.

Additionally, or alternatively, the processing system 920 may support wireless communications in accordance with examples as disclosed herein. For example, the processing system 920 is capable of, configured to, or operable to support a means for obtaining, from a UE, information indicating a SIC capability of the UE. The processing system 920 is capable of, configured to, or operable to support a means for outputting a first transmission including a first codeword and a second codeword. The processing system 920 is capable of, configured to, or operable to support a means for obtaining, in response to the first transmission, a feedback message that indicates whether the first codeword was successfully decoded, whether the second codeword was successfully decoded, or both. The processing system 920 is capable of, configured to, or operable to support a means for outputting, in response to the feedback message and in accordance with the SIC capability of the UE, a second transmission including the first codeword and the second codeword, where the first codeword is associated with a first MCS value and the second codeword is associated with a second MCS value, the first MCS value different from the second MCS value.

By including or configuring the processing system 920 in accordance with examples as described herein, the device 905 (e.g., at least one processor controlling or otherwise coupled with the receiver 910, the transmitter 915, the processing system 920, or a combination thereof) may support techniques for more efficient utilization of communication resources.

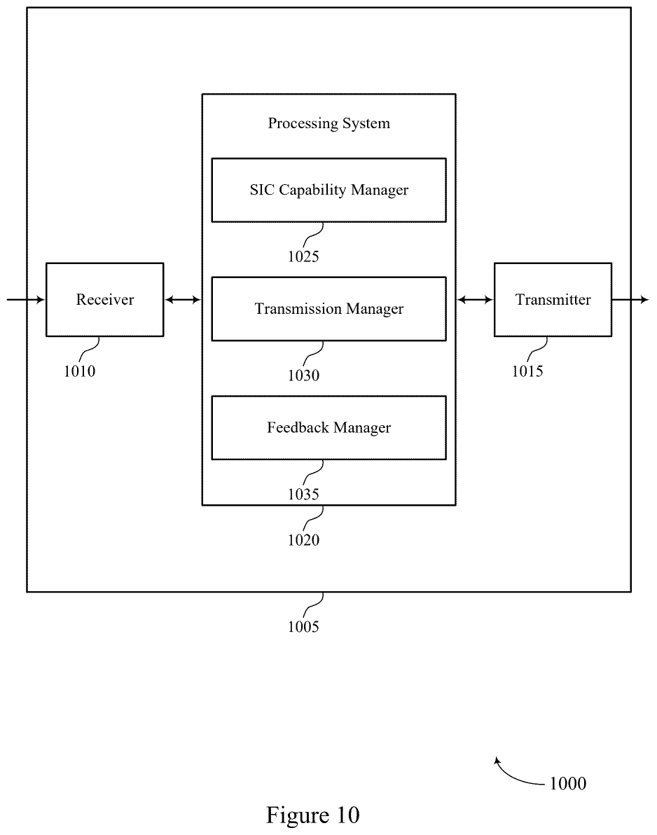

FIG. 10 shows a block diagram 1000 of a device 1005 that supports outer loop link adaptation adjustment for wireless communications. The device 1005 may be an example of aspects of a device 905 or a network entity 105 as described herein. The device 1005 may include a processing system 1020. The device 1005, or one or more components of the device 1005 (e.g., the processing system 1020), may include at least one processor, which may be coupled with at least one memory, to support the described techniques. Each of these components may be in communication with one another (e.g., via one or more buses).

The receiver 1010 may provide a means for receiving information such as packets, user data, control information, or any combination thereof associated with various information channels (e.g., control channels, data channels, information channels related to techniques for uplink narrow beam prediction). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to techniques for uplink narrow beam prediction). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of outer loop link adaptation adjustment for wireless communications as described herein. For example, the processing system 1020 may include an SIC capability manager 1025, a transmission manager 1030, a feedback manager 1035, or any combination thereof. The processing system 1020 may be an example of aspects of a processing system 920 as described herein. In some examples, the processing system 1020, or various components thereof, may be configured to perform various operations (e.g., receiving, obtaining, monitoring, outputting, transmitting) using or otherwise in cooperation with the receiver 1010, the transmitter 1015, or both. For example, the processing system 1020 may receive information from the receiver 1010, send information to the transmitter 1015, or be integrated in combination with the receiver 1010, the transmitter 1015, or both to obtain information, output information, or perform various other operations as described herein.

The processing system 1020 may support wireless communications in accordance with examples as disclosed herein. The transmission manager 1030 may support wireless communications in accordance with examples as disclosed herein. For example, the transmission manager 1030 is capable of, configured to, or operable to support a means for obtaining, from a UE, information indicating one or more MCS values to skip from among a set of MCS values. The transmission manager 1030 is capable of, configured to, or operable to support a means for outputting a first transmission in accordance with a first MCS value included in the set of MCS values. The feedback manager 1035 is capable of, configured to, or operable to support a means for obtaining, in response to the first transmission, a feedback message that indicates whether the first transmission was successfully decoded. The transmission manager 1030 is capable of, configured to, or operable to support a means for outputting, in response to the feedback message, a second transmission in accordance with a second MCS value included in the set of MCS values, where the second MCS value is not one of the one or more MCS values to skip.

Additionally, or alternatively, the SIC capability manager 1025 is capable of, configured to, or operable to support a means for obtaining, from a UE, information indicating a SIC capability of the UE. The transmission manager 1030 is capable of, configured to, or operable to support a means for outputting a first transmission including a first codeword and a second codeword. The feedback manager 1035 is capable of, configured to, or operable to support a means for obtaining, in response to the first transmission, a feedback message that indicates whether the first codeword was successfully decoded, whether the second codeword was successfully decoded, or both. The transmission manager 1030 is capable of, configured to, or operable to support a means for outputting, in response to the feedback message and in accordance with the SIC capability of the UE, a second transmission including the first codeword and the second codeword, where the first codeword is associated with a first MCS value and the second codeword is associated with a second MCS value, the first MCS value different from the second MCS value.

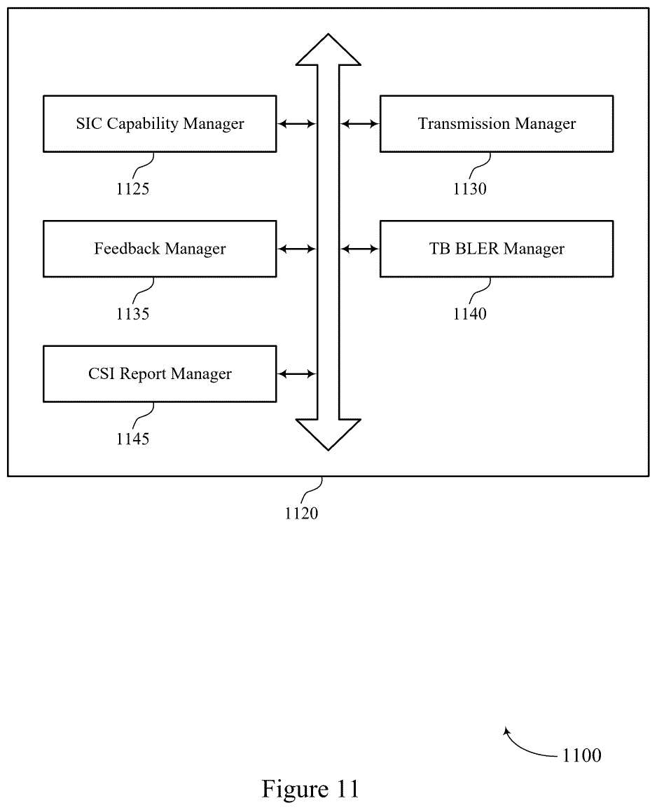

FIG. 11 shows an example of a processing system 1120 that supports outer loop link adaptation adjustment for wireless communications. A processing system 1120 may be an example of a processing system 145 (such as network entity 105) and may include an SIC capability manager 1125, a transmission manager 1130, a feedback manager 1135, a TB BLER manager 1140, a CSI report manager 1145, or any combination thereof. A processing system 1120, or various component thereof, may be an example of means for performing (such as a means for causing a network entity 105 to perform) various techniques described herein.

The transmission manager 1130 may be configured to cause the network entity 105 to obtain, from a UE, information indicating one or more MCS values to skip from among a set of MCS values. The transmission manager 1130 may be configured to cause the network entity 105 to output a first transmission in accordance with a first MCS value included in the set of MCS values. The feedback manager 1135 may be configured to cause the network entity 105 to obtain, in response to the first transmission, a feedback message that indicates whether the first transmission was successfully decoded. The transmission manager 1130 may be configured to cause the network entity 105 to output, in response to the feedback message, a second transmission in accordance with a second MCS value included in the set of MCS values, where the second MCS value is not one of the one or more MCS values to skip.

In some examples, the one or more MCS values to skip are associated with one or more ranks or one or more layer mapping schemes.

In some examples, to support obtaining the information, the transmission manager 1130 may be configured to cause the network entity 105 to obtain, from the UE, a capability report indicating the one or more MCS values to skip.

In some examples, the information is obtained periodically or in response to a trigger event.

Additionally, or alternatively, the SIC capability manager 1125 may be configured to cause the network entity 105 to obtain, from a UE, information indicating a SIC capability of the UE. The transmission manager 1130 may be configured to cause the network entity 105 to output a first transmission including a first codeword and a second codeword. The feedback manager 1135 may be configured to cause the network entity 105 to obtain, in response to the first transmission, a feedback message that indicates whether the first codeword was successfully decoded, whether the second codeword was successfully decoded, or both. In some examples, the transmission manager 1130 may be configured to cause the network entity 105 to output, in response to the feedback message and in accordance with the SIC capability of the UE, a second transmission including the first codeword and the second codeword, where the first codeword is associated with a first MCS value and the second codeword is associated with a second MCS value, the first MCS value different from the second MCS value.

In some examples, the TB BLER manager 1140 may be configured to cause the network entity 105 to determine a TB BLER target associated with the second codeword in accordance with whether the feedback message indicates a successful decode for the first codeword.

In some examples, the TB BLER manager 1140 may be configured to cause the network entity 105 to obtain a message indicating one or more TB BLER target values associated with at least one of the first codeword or the second codeword.

In some examples, the one or more TB BLER target values are associated with one or more ranks or one or more layer mapping schemes.

In some examples, the message indicates a first TB BLER target value associated with the first codeword and a second TB BLER target value associated with the second codeword.

In some examples, the second TB BLER target value is a conditional BLER target or an unconditional BLER target.

In some examples, the CSI report manager 1145 may be configured to cause the network entity 105 to obtain a channel state information report that indicates a SIC order associated with the first codeword and the second codeword.

A processing system 1120 may include or be an example of one or more chips, SoCs, chipsets, packages, components, or devices that individually or collectively constitute or include a processing system. A processing system 1120 may interface with other components of a network entity 105. For example, operations described with reference to a processing system 1120, or various components thereof, may be performed by or with other such components, including a receiver, a transmitter, a transceiver, a modem, a user interface, a modulator/demodulator, an encoder/decoder, or any combination thereof (such as of the processing system 1120, coupled with the processing system 1120, of a network entity 105). Operations described herein with reference to the processing system 1120, or various components thereof, may be performed by or with other such components, including a CU 160, a DU 165, an RU 170, or any combination thereof. Each of one or more of any of such components, or subcomponents thereof (such as one or more processors, one or more memories), may communicate, directly or indirectly, with one another. The communication may include communication within a protocol layer of a protocol stack, communication associated with a logical channel of a protocol stack (such as between protocol layers of a protocol stack, within a device, component, or virtualized component associated with a network entity 105, between devices, components, or virtualized components associated with a network entity 105), or any combination thereof.

By including or configuring a processing system 1120 for operation in a processing system 1120 as described herein, the processing system 1120 may support techniques for more efficient utilization of communication resources.

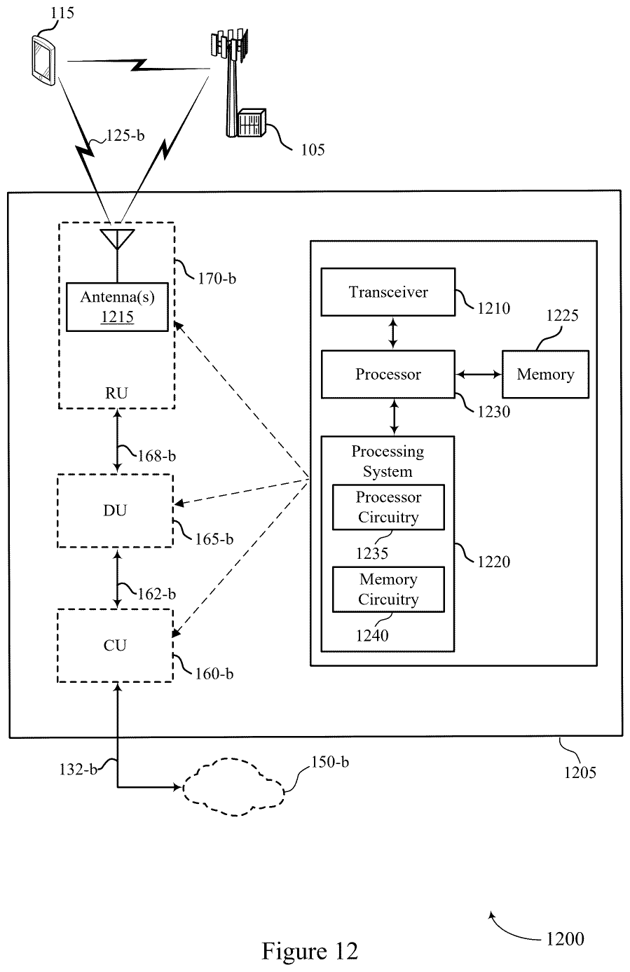

FIG. 12 shows an example of a system 1200 including a device 1205 that supports outer loop link adaptation adjustment for wireless communications. The device 1205 may be an example of or include components of a device 905, a device 1005, or a network entity 105 as described herein. The device 1205 may communicate (such as via one or more wired interfaces or one or more wireless interfaces) with other network devices or network equipment such as a core network 150-b, other network entities 105, UEs 115, or any combination thereof. The device 1205 may include components for transmitting and receiving communication, which may include a processing system 1220, a transceiver 1210, antenna(s) 1215, a memory 1225, and a processor 1230. Components of the device 1205 may be coupled (such as operatively, communicatively, functionally, electronically, electrically, in electronic communication) via one or more interfaces.

The transceiver 1210 may communicate bi-directionally with another transceiver via wired or wireless links, and may support transmission operations, reception operations, or both, as described herein. The transceiver 1210 may include a modem to modulate and demodulate signals, to provide the modulated signals for transmission (such as via antenna(s) 1215, via a wired interface), and to demodulate received signals (such as received via antenna(s) 1215, received via a wired interface). The transceiver 1210 may be operable to support communication via one or more communication links (such as a communication link 125-b, a backhaul link 132-b, a midhaul link 162-b, fronthaul link 168-b).

The processor 1230 may be a general-purpose processing component that supports various operations (such as applications) of the device 1205. The memory 1225 may be a general-purpose storage component that stores code executable by the processor 1230. Such code may include instructions that, when executed by the processor 1230, cause the device 1205 to perform various functions (such as to support an application of the device 1205).

For examples in which the device 1205 is a network entity 105 in a disaggregated architecture, one or more components of the device 1205 may be located at one or more of a CU 160-b, a DU 165-b, or an RU 170-b, one or more of which may include aspects of the processing system 1220, the processor 1230, the memory 1225, or the transceiver 1210. Functions of the device 1205 may be performed at different components or an operation may be divided between different components (such as different functions being supported by aspects of the CU 160-b, the DU 165-b, or the RU 170-b, the transceiver 1210, the processor 1230, the memory 1225, the processing system 1220, or any combination thereof). For example, the processing system 1220 may be a component of one or more of the CU 160-b, the DU 165-b, or the RU 170-b. In some examples, interfaces between components of device 1205 (such as CU 160-b, DU 165-b, RU 170-b) may support communication at a protocol layer or between protocol layers of a protocol stack.

In some examples, the processing system 1220 may manage aspects of communication with the core network 150-b (such as via a backhaul link 132). For example, the processing system 1220 may manage the transfer of data communication for UEs 115 with a gateway of the core network 150-b. In some examples, the processing system 1220 may manage communication with one or more other network entities 105 and may include a controller or scheduler for controlling communication with UEs 115 (such as in cooperation with the one or more other network entities 105). In some examples, the processing system 1220 may support an interface (such as X2 interface, Xn interface) to provide communication between network entities 105.

The processing system 1220 may be an example of a processing system 145 or a processing system 1100. For example, the processing system 1220 may include processor circuitry 1235 and memory circuitry 1240 that stores code, and the processing system 1220 may be configured to cause the device 1205 to perform operations that support outer loop link adaptation adjustment for wireless communications. Although the processing system 1220 is illustrated as a separate component, which may involve a separate chip, chipset, or other module, in some implementations, one or more functions described with reference to the processing system 1220 may be supported by or performed by a transceiver 1210, antenna(s) 1215, a processor 1230, memory 1225, or any combination thereof, such that a processing system 1220 may include one or more of a transceiver 1210, antenna(s) 1215, a processor 1230, memory 1225, or any combination thereof. Further, processor circuitry 1235 and memory circuitry 1240 each may be implemented at the device 1205 in accordance with an aggregated architecture, or the processor circuitry 1235 and the memory circuitry 1240 may be implemented at one or more of a CU 160-b, a DU 165-b, or an RU 170-b in accordance with a disaggregated architecture.

By including or configuring the processing system 1220 for operation in the device 1205 as described herein, may support techniques for improved communication reliability, reduced latency, more efficient utilization of communication resources, and improved coordination between devices.

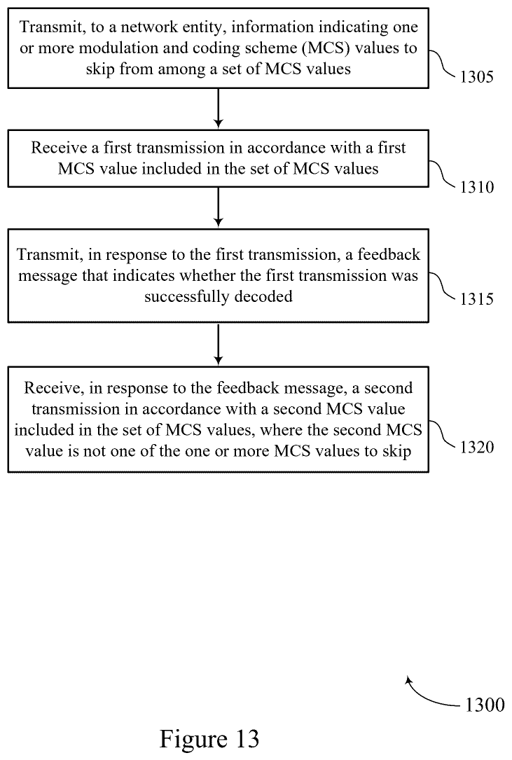

FIG. 13 shows an example of a method 1300 that supports outer loop link adaptation adjustment for wireless communications. Operations of the method 1300 may be performed by a UE or its components (such as using a processing system configured to cause the UE 115 to perform one or more of the operations) as described herein.

At 1305, the method may include transmitting, to a network entity, information indicating one or more MCS values to skip from among a set of MCS values. In some examples, aspects of the operations of 1305 may be performed by an MCS manager 725.

At 1310, the method may include receiving a first transmission in accordance with a first MCS value included in the set of MCS values. In some examples, aspects of the operations of 1310 may be performed by a transmission manager 730.

At 1315, the method may include transmitting, in response to the first transmission, a feedback message that indicates whether the first transmission was successfully decoded. In some examples, aspects of the operations of 1315 may be performed by a feedback manager 735.

At 1320, the method may include receiving, in response to the feedback message, a second transmission in accordance with a second MCS value included in the set of MCS values, where the second MCS value is not one of the one or more MCS values to skip. In some examples, aspects of the operations of 1320 may be performed by a transmission manager 730.

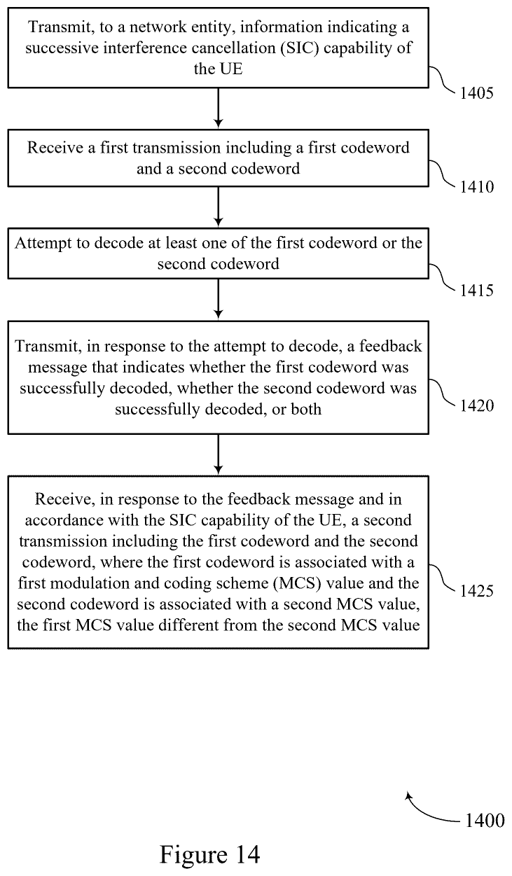

FIG. 14 shows an example of a method 1400 that supports outer loop link adaptation adjustment for wireless communications. Operations of the method 1400 may be performed by a UE or its components (such as using a processing system configured to cause the UE 115 to perform one or more of the operations) as described herein.

At 1405, the method may include transmitting, to a network entity, information indicating a SIC capability of the UE. In some examples, aspects of the operations of 1405 may be performed by an SIC capability manager 740.

At 1410, the method may include receiving a first transmission including a first codeword and a second codeword. In some examples, aspects of the operations of 1410 may be performed by a transmission manager 730.

At 1415, the method may include attempting to decode at least one of the first codeword or the second codeword. In some examples, aspects of the operations of 1415 may be performed by a decoding manager 745.

At 1420, the method may include transmitting, in response to the attempt to decode, a feedback message that indicates whether the first codeword was successfully decoded, whether the second codeword was successfully decoded, or both. In some examples, aspects of the operations of 1420 may be performed by a feedback manager 735.

At 1425, the method may include receiving, in response to the feedback message and in accordance with the SIC capability of the UE, a second transmission including the first codeword and the second codeword, where the first codeword is associated with a first MCS value and the second codeword is associated with a second MCS value, the first MCS value different from the second MCS value. In some examples, aspects of the operations of 1425 may be performed by a transmission manager 730.

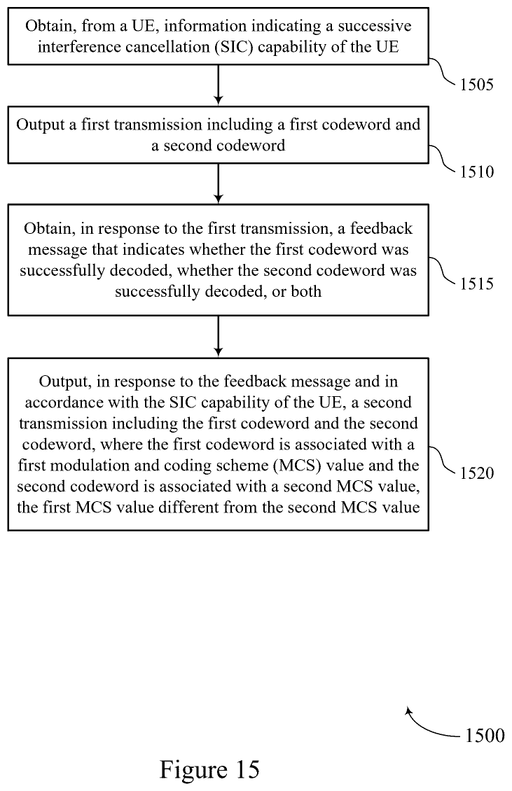

FIG. 15 shows an example of a method 1500 that supports outer loop link adaptation adjustment for wireless communications. Operations of the method 1500 may be performed by a network entity 105 or its components (such as using a processing system configured to cause the network entity to perform one or more operations) as described herein.

At 1505, the method may include obtaining, from a UE, information indicating a SIC capability of the UE. In some examples, aspects of the operations of 1505 may be performed by an SIC capability manager 1125.

At 1510, the method may include outputting a first transmission including a first codeword and a second codeword. In some examples, aspects of the operations of 1510 may be performed by a transmission manager 1130.

At 1515, the method may include obtaining, in response to the first transmission, a feedback message that indicates whether the first codeword was successfully decoded, whether the second codeword was successfully decoded, or both. In some examples, aspects of the operations of 1515 may be performed by a feedback manager 1135.

At 1520, the method may include outputting, in response to the feedback message and in accordance with the SIC capability of the UE, a second transmission including the first codeword and the second codeword, where the first codeword is associated with a first MCS value and the second codeword is associated with a second MCS value, the first MCS value different from the second MCS value. In some examples, aspects of the operations of 1520 may be performed by a transmission manager 1130.

Aspect 1: A method for wireless communications by a UE, comprising: transmitting, to a network entity, information indicating one or more MCS values to skip from among a set of MCS values; receiving a first transmission in accordance with a first MCS value included in the set of MCS values; transmitting, in response to the first transmission, a feedback message that indicates whether the first transmission was successfully decoded; and receiving, in response to the feedback message, a second transmission in accordance with a second MCS value included in the set of MCS values, wherein the second MCS value is not one of the one or more MCS values to skip.

Aspect 2: The method of aspect 1, wherein the one or more MCS values to skip are associated with one or more ranks or one or more layer mapping schemes.

Aspect 3: The method of any of aspects 1 through 2, wherein transmitting the information comprises: transmitting, to the network entity, a capability report indicating the one or more MCS values to skip.

Aspect 4: The method of any of aspects 1 through 3, wherein the information is transmitted periodically or in response to a trigger event.

Aspect 5: A method for wireless communications by a UE, comprising: transmitting, to a network entity, information indicating a SIC capability of the UE; receiving a first transmission comprising a first codeword and a second codeword; attempting to decode at least one of the first codeword or the second codeword; transmitting, in response to the attempt to decode, a feedback message that indicates whether the first codeword was successfully decoded, whether the second codeword was successfully decoded, or both; and receiving, in response to the feedback message and in accordance with the SIC capability of the UE, a second transmission comprising the first codeword and the second codeword, wherein the first codeword is associated with a first MCS value and the second codeword is associated with a second MCS value, the first MCS value different from the second MCS value.

Aspect 6: The method of aspect 5, wherein the SIC capability is indicated per frequency band or frequency band combination.

Aspect 7: The method of any of aspects 5 through 6, wherein the second MCS value is associated with a transport block TB BLER target in accordance with successful decoding of the first codeword.

Aspect 8: The method of any of aspects 5 through 7, further comprising: transmitting, to the network entity, a message indicating one or more transport block TB BLER target values associated with at least one of the first codeword or the second codeword.

Aspect 9: The method of aspect 8, wherein the one or more TB BLER target values are associated with one or more ranks or one or more layer mapping schemes.

Aspect 10: The method of any of aspects 8 through 9, wherein the one or more TB BLER target values are transmitted periodically or in response to a trigger event.

Aspect 11: The method of any of aspects 8 through 10, wherein the message indicates a first TB BLER target value associated with the first codeword and a second TB BLER target value associated with the second codeword.

Aspect 12: The method of aspect 11, wherein the second TB BLER target value is a conditional BLER target or an unconditional BLER target.

Aspect 13: The method of any of aspects 5 through 12, further comprising: transmitting, to the network entity, a channel state information report that indicates a SIC order associated with the first codeword and the second codeword.

Aspect 14: A method for wireless communications by a network entity, comprising: obtaining, from a UE, information indicating a SIC capability of the UE; outputting a first transmission comprising a first codeword and a second codeword; obtaining, in response to the first transmission, a feedback message that indicates whether the first codeword was successfully decoded, whether the second codeword was successfully decoded, or both; and outputting, in response to the feedback message and in accordance with the SIC capability of the UE, a second transmission comprising the first codeword and the second codeword, wherein the first codeword is associated with a first MCS value and the second codeword is associated with a second MCS value, the first MCS value different from the second MCS value.

Aspect 15: The method of aspect 14, further comprising: determining a TB BLER target associated with the second codeword in accordance with whether the feedback message indicates a successful decode for the first codeword.

Aspect 16: The method of any of aspects 14 through 15, further comprising: obtaining a message indicating one or more TB BLER target values associated with at least one of the first codeword or the second codeword.

Aspect 17: The method of aspect 16, wherein the one or more TB BLER target values are associated with one or more ranks or one or more layer mapping schemes.

Aspect 18: The method of any of aspects 16 through 17, wherein the message indicates a first TB BLER target value associated with the first codeword and a second TB BLER target value associated with the second codeword.

Aspect 19: The method of aspect 18, wherein the second TB BLER target value is a conditional BLER target or an unconditional BLER target.

Aspect 20: The method of any of aspects 14 through 19, further comprising: obtaining a channel state information report that indicates a SIC order associated with the first codeword and the second codeword.

Aspect 21: A UE for wireless communications, comprising a processing system that includes processor circuitry and memory circuitry that stores code, the processing system configured to cause the UE to perform a method of any of aspects 1 through 4.

Aspect 22: A UE for wireless communications, comprising at least one means for performing a method of any of aspects 1 through 4.

Aspect 23: A non-transitory computer-readable medium storing code for wireless communications, the code comprising instructions executable by one or more processors to perform a method of any of aspects 1 through 4.

Aspect 24: A UE for wireless communications, comprising a processing system that includes processor circuitry and memory circuitry that stores code, the processing system configured to cause the UE to perform a method of any of aspects 5 through 13.

Aspect 25: A UE for wireless communications, comprising at least one means for performing a method of any of aspects 5 through 13.

Aspect 26: A non-transitory computer-readable medium storing code for wireless communications, the code comprising instructions executable by one or more processors to perform a method of any of aspects 5 through 13.

Aspect 27: A network entity for wireless communications, comprising a processing system that includes processor circuitry and memory circuitry that stores code, the processing system configured to cause the network entity to perform a method of any of aspects 14 through 20.

Aspect 28: A network entity for wireless communications, comprising at least one means for performing a method of any of aspects 14 through 20.

Aspect 29: A non-transitory computer-readable medium storing code for wireless communications, the code comprising instructions executable by one or more processors to perform a method of any of aspects 14 through 20.

It should be noted that methods described herein describe possible implementations. Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

As used herein, a processing system (such as a processing system 140, a processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other examples, each of a group of processors may be configured to cause a device to perform a same set of functions.

As used herein, a processing system (such as a processing system 140, a processing system 145) also includes memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors, may cause a device (such as configure the device, using one or more of the processors) to perform functions or operations described herein. Additionally, or alternatively, in some examples, one or more of the processors may be configured to cause a device to perform functions or operations described herein without requiring configuration by software. As used herein, “Software” shall be construed to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, a processing system (such as a processing system 140, a processing system 145) may include or be coupled with one or more modems (such as a cellular modem, a 5G-compliant modem, a 6G-compliant modem). In some examples, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some examples, one or more processors of a processing system may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

As used herein, the term “determine” or “determining” can encompass one or more of a variety of actions. For example, “determining” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining can involve a processing system performing some type of calculating, computing, deriving, estimating, inferring, ascertaining, resolving, predicting, or other processing to obtain one or more numerical values, sets, elements, or other information or results. In some such examples, determining can involve a processing system identifying, looking up, investigating, or otherwise obtaining some type of value, set, element, or other information or result from a table, data structure, database, or an implementation of memory, such as from a larger set of values, sets, or elements or other information or results. In some such examples, determining can involve a processing system identifying, interpreting, demodulating, decoding, detecting, reading, or otherwise obtaining some type of value, set, element, or other information or result signaled in, for example, a received wireless signal. In some such examples, determining can involve a processing system performing a measurement, such as on a received signal.

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components or actions, among other examples. The phrase “associated with” may be interpreted to mean or be interchanged with “in association with,” “in accordance with,” “based on,” “based at least in part on,” “as a function of,” “in response to,” “responsive to,” “using,” “coupled with,” in communication with,” “configured with,” “included with,” or “in cooperation with,” as appropriate in the relevant context unless otherwise explicitly indicated. Additionally, the use of such phrases does not indicate that what follows the phrase is the focal point or primary factor associated with the limitation preceding the phrase.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b.

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
a processing system that includes processor circuitry and memory circuitry that stores code, the processing system configured to cause the UE to:
transmit, to a network entity, information indicating one or more modulation and coding scheme (MCS) values to skip from among a set of MCS values;
receive a first transmission in accordance with a first MCS value included in the set of MCS values;
transmit, in response to the first transmission, a feedback message that indicates whether the first transmission was successfully decoded; and
receive, in response to the feedback message, a second transmission in accordance with a second MCS value included in the set of MCS values, wherein the second MCS value is not one of the one or more MCS values to skip.

2. The UE of claim 1, wherein the one or more MCS values to skip are associated with one or more ranks or one or more layer mapping schemes.

3. The UE of claim 1, wherein, to transmit the information, the processing system is configured to cause the UE to:
transmit, to the network entity, a capability report indicating the one or more MCS values to skip.

4. The UE of claim 1, wherein the information is transmitted periodically or in response to a trigger event.

5. A user equipment (UE), comprising:
a processing system that includes processor circuitry and memory circuitry that stores code, the processing system configured to cause the UE to:
transmit, to a network entity, information indicating a successive interference cancellation (SIC) capability of the UE;
receive a first transmission comprising a first codeword and a second codeword;
attempt to decode at least one of the first codeword or the second codeword;
transmit, in response to the attempt to decode, a feedback message that indicates whether the first codeword was successfully decoded, whether the second codeword was successfully decoded, or both; and
receive, in response to the feedback message and in accordance with the SIC capability of the UE, a second transmission comprising the first codeword and the second codeword, wherein the first codeword is associated with a first modulation and coding scheme (MCS) value and the second codeword is associated with a second MCS value, the first MCS value different from the second MCS value.

6. The UE of claim 5, wherein the SIC capability is indicated per frequency band or frequency band combination.

7. The UE of claim 5, wherein the second MCS value is associated with a transport block (TB) block error rate (BLER) target in accordance with successful decoding of the first codeword.

8. The UE of claim 5, wherein the processing system is further configured to cause the UE to:
transmit, to the network entity, a message indicating one or more transport block (TB) block error rate (BLER) target values associated with at least one of the first codeword or the second codeword.

9. The UE of claim 8, wherein the one or more TB BLER target values are associated with one or more ranks or one or more layer mapping schemes.

10. The UE of claim 8, wherein the one or more TB BLER target values are transmitted periodically or in response to a trigger event.

11. The UE of claim 8, wherein the message indicates a first TB BLER target value associated with the first codeword and a second TB BLER target value associated with the second codeword.

12. The UE of claim 11, wherein the second TB BLER target value is a conditional BLER target or an unconditional BLER target.

13. The UE of claim 5, wherein the processing system is further configured to cause the UE to:
transmit, to the network entity, a channel state information report that indicates a SIC order associated with the first codeword and the second codeword.

14. A network entity, comprising:
a processing system that includes processor circuitry and memory circuitry that stores code, the processing system configured to cause the network entity to:
obtain, from a user equipment (UE), information indicating a successive interference cancellation (SIC) capability of the UE;
output a first transmission comprising a first codeword and a second codeword;
obtain, in response to the first transmission, a feedback message that indicates whether the first codeword was successfully decoded, whether the second codeword was successfully decoded, or both; and
output, in response to the feedback message and in accordance with the SIC capability of the UE, a second transmission comprising the first codeword and the second codeword, wherein the first codeword is associated with a first modulation and coding scheme (MCS) value and the second codeword is associated with a second MCS value, the first MCS value different from the second MCS value.

15. The network entity of claim 14, wherein the processing system is further configured to cause the network entity to:
determine a transport block (TB) block error rate (BLER) target associated with the second codeword in accordance with whether the feedback message indicates a successful decode for the first codeword.

16. The network entity of claim 14, wherein the processing system is further configured to cause the network entity to:
obtain a message indicating one or more transport block (TB) block error rate (BLER) target values associated with at least one of the first codeword or the second codeword.

17. The network entity of claim 16, wherein the one or more TB BLER target values are associated with one or more ranks or one or more layer mapping schemes.

18. The network entity of claim 16, wherein the message indicates a first TB BLER target value associated with the first codeword and a second TB BLER target value associated with the second codeword.

19. The network entity of claim 18, wherein the second TB BLER target value is a conditional BLER target or an unconditional BLER target.

20. The network entity of claim 14, wherein the processing system is further configured to cause the network entity to:
obtain a channel state information report that indicates a SIC order associated with the first codeword and the second codeword.
